(19) United States
(12) Patent Application Publication
(10) Pub. No.: US 2019/0026000 A1
(43) Pub. Date: Jan. 24, 2019

(54) MANAGEMENT OF ORDERED LISTS OF DATA OBJECTS

(71) Applicant: PROSPEROWARE LLC, Bala Cynwyd, PA (US)

(72) Inventor: Keith Lipman, Bala Cynwyd, PA (US)

(73) Assignee: Prosperoware LLC, Bala Cynwyd, PA (US)

(21) Appl. No.: 16/140,474

(22) Filed: Sep. 24, 2018

Related U.S. Application Data
(63) Continuation-in-part of application No. 14/671,596, filed on Mar. 27, 2015.
(60) Provisional application No. 61/974,412, filed on Apr. 2, 2014.

(51) Int. Cl. G06F 3/0486; G06F 3/0482; G06F 17/30; G06F 17/24

(52) U.S. Cl. CPC G06F 3/0486; G06F 17/248; G06F 17/30958; G06F 3/0482

(57) ABSTRACT

An editor for management of ordered lists of data objects provides a drag-and-drop interface (UI) for managing lists of data objects, such as a matter object, that includes associated procedure objects. Once the matter is defined, the user associates one or more procedures to the matter. Objects are defined by selecting an object template from a list of object types and dragging an instantiation of the template to a workspace. Attributes may be pre-defined and narratives templatized. Metadata for the object may be supplied by the user. Procedures are associated are associated to the matter by dragging procedure template to a UI representation of the matter. The procedure is then further defined by customizing templatized attributes and narratives. The matter object is displayed as an ordered list of procedure objects within the UI representation of the matter object. The list is formatted as either a checklist or a budget.

### CROSS REFERENCE TO RELATED APPLICATIONS

This application is a continuation-in-part of U.S. patent application Ser. No. 14/671,596, filed Mar. 27, 2015; and

U.S. patent application Ser. No. 14/671,596 claims benefit of U.S. provisional patent application Ser. No. 61/974,412, filed Apr. 2, 2014, both of which applications are incorporated herein in their entireties by this reference.

### BACKGROUND OF THE INVENTION

### Field of the Invention

In general, the subject matter herein described is related to devices for data management. More particularly, it is related to an editor for management of ordered lists of data objects.

### Background Information

In recent years, law firms and other service organizations have been under significant pressure to provide service at lower cost and to provide greater predictability and transparency in the billing process. One manifestation of this trend is that professional service providers are expected to thoroughly document exactly the services provided. Thus, they are expected to provide detailed narrative descriptions of the services performed for each line item in a bill. It has become commonplace for clients to refuse to pay for a service if the narrative description does not comply with their internal disclosure standards. In fact, invoice review is increasingly being performed by sophisticated computing devices programmed to capture invoice data and direct it to an electronic workflow, so that an invoice can be processed, reviewed and possibly rejected without being seen by human eyes.

### SUMMARY

An editor for management of ordered lists of data objects provides a drag-and-drop interface (UI) for managing lists of data objects, such as a matter object, that includes associated procedure objects. Once the matter is defined, the user associates one or more procedures to the matter. Objects are defined by selecting an object template from a list of object types and dragging an instantiation of the template to a workspace. Attributes may be pre-defined and narratives templatized. Metadata for the object may be supplied by the user. Procedures are associated to the matter by dragging a procedure template to a UI representation of the matter. The procedure is then further defined by customizing templatized attributes and narratives. The matter object is displayed as an ordered list of procedure objects within the UI representation of the matter object. The list is formatted as either a checklist or a budget.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram of an exemplary network architecture in which a verb-based project management system may be implemented;

FIG. 2 is a block diagram of a computer system suitable for implementing a verb-based project management system;

FIG. 3 shows an overview of a budget mode from a user interface for verb-based project management;

FIG. 4 shows a time budget amount monitor from a user interface for verb-based project management;

FIG. 5 shows an ‘Add hours’ tool;

FIG. 6 shows a tool for specifying a budget cap;

FIG. 7 shows a tool for specifying an amount distribution;

FIG. 8 shows a tool for viewing and adding procedures to a budget;

FIG. 9 shows an ‘Add procedure’ tool;

FIG. 10 shows a tool for adding expenses to a budget;

FIG. 11 shows a tool for defining a phase;

FIG. 12 shows a tool for re-allocation of resources;

FIG. 13 shows a view of a project checklist;

FIG. 14 shows a tool for adding a phase to a matter checklist;

FIG. 15 shows a tool for adding a procedure to a phase within a project checklist;

FIG. 16 shows a tool for adding an activity to a procedure from a project checklist;

FIG. 17 shows a tool for adding a cost to procedure from a project checklist;

FIG. 18 provides a flow diagram of a process for building an experience store for experience scoring;

FIG. 19 provides a flow diagram of a process for applying experience scoring to a person;

FIG. 20 provides a flow diagram of a process for finding a person having a predetermined background of experience;

FIG. 21 provides a flow diagram of a process for defining a verb-based template;

FIG. 22 provides a flow diagram of a process for grouping verb-based templates based on phases;

FIG. 23 provides a flow diagram of a process for grouping phases with filters;

FIG. 24 provides a flow diagram of a process for creating a budget with verb-based templates;

FIG. 25 provides a flow diagram of a process for creating a top-down budget; and

FIG. 26 provides a flow diagram of comparing a bottom-up budget with a top-down budget.

FIG. 27 provides a screen shot of a device interface for managing ordered lists of data objects;

FIG. 28 provides an additional screen shot of a device interface for managing ordered lists of data objects;

FIG. 29 provides a further screen shot of a device interface for managing ordered lists of data objects; and

FIG. 30 provides a still further screen shot of a device interface for managing ordered lists of data objects.

### DESCRIPTION

An editor for management of ordered lists of data objects provides a drag-and-drop interface (UI) for managing lists of data objects, such as a matter object, that includes associated procedure objects. Once the matter is defined, the user associates one or more procedures to the matter. Objects are defined by selecting an object template from a list of object types and dragging an instantiation of the template to a workspace. Attributes may be pre-defined and narratives templatized. Metadata for the object may be supplied by the user. Procedures are associated to the matter by dragging a procedure template to a UI representation of the matter. The procedure is then further defined by customizing templatized attributes and narratives. The matter object is displayed as an ordered list of procedure objects within the UI representation of the matter object. The list is formatted as either a checklist or a budget.

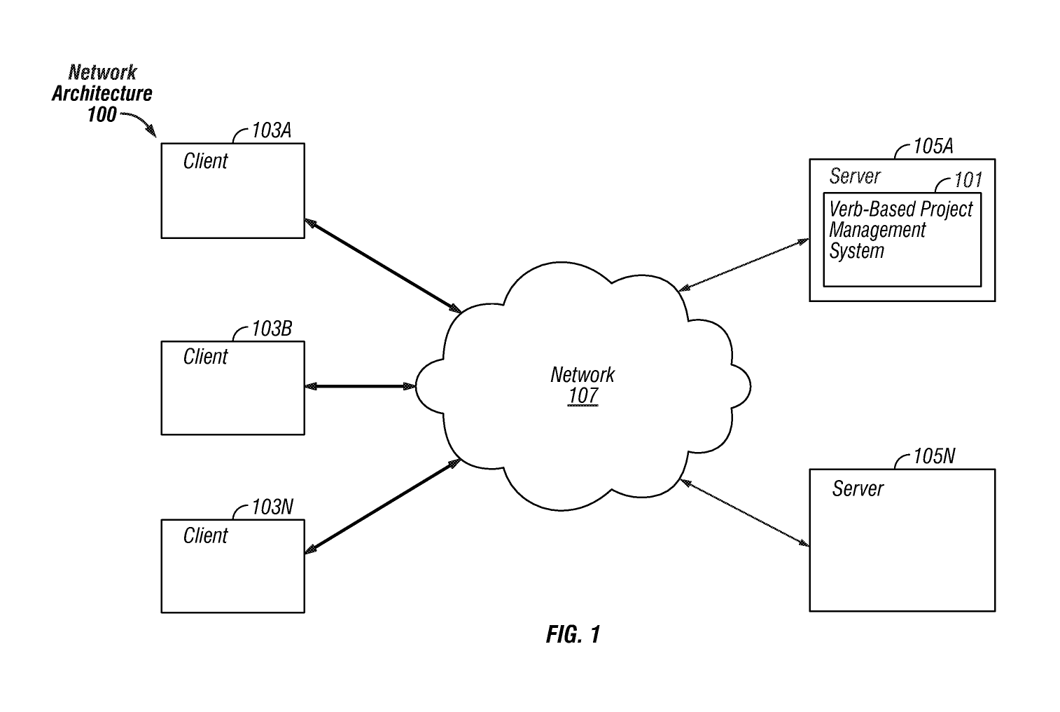

FIG. 1 is a block diagram illustrating an exemplary network architecture 100 in which a verb-based project management system 101 may be implemented. The illustrated network architecture 100 comprises multiple clients 103A, 103B and 103N, as well as multiple servers 105A and 105N. In FIG. 1, the verb-based project management system 101 is illustrated as residing on server 105A. It is to be understood that this is an example only, and in various embodiments various functionalities of this system 101 may be instantiated on a server 105, a client 103, or may be distributed between multiple clients 103 and/or servers 105.

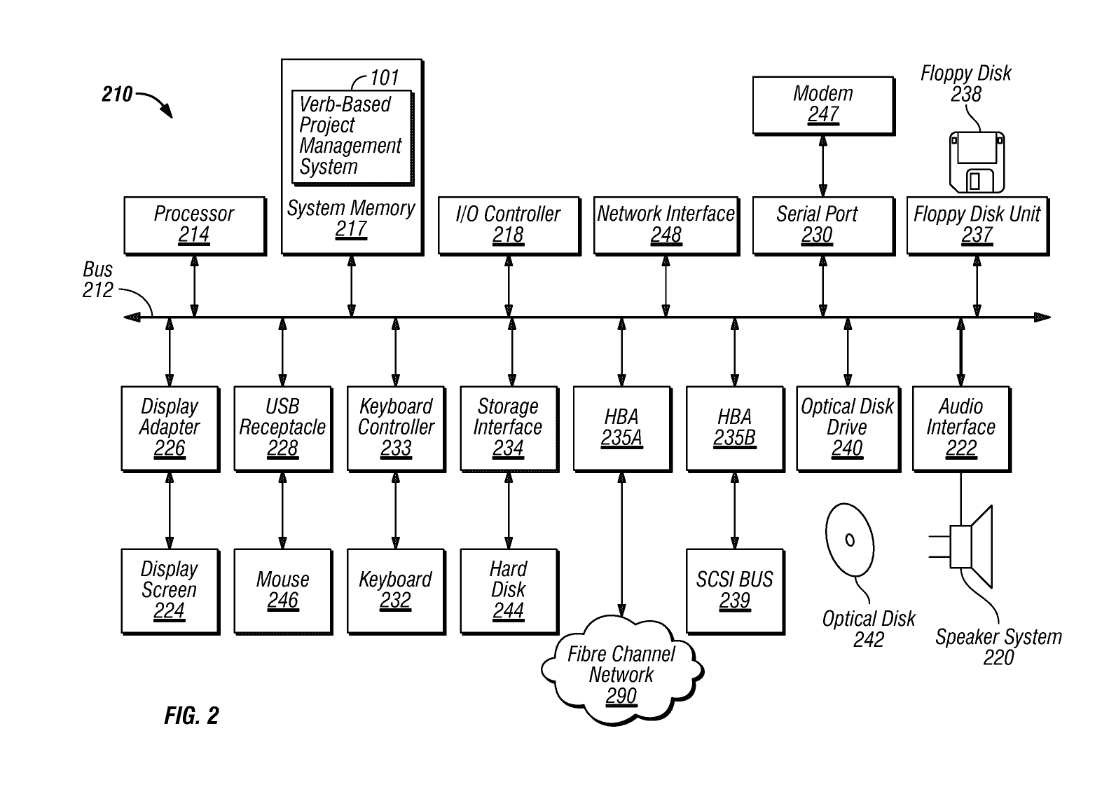

Clients 103 and servers 105 may be implemented using computer systems 210 such as the one illustrated in FIG. 2 and described below. The clients 103 and servers 105 are communicatively coupled to a network 107, for example via a network interface 248 or modem 247 as described below in conjunction with FIG. 2. Clients 103 are able to access applications and/or data on servers 105 using, for example, a web browser or other client software (not shown). Clients 103 may, but need not, be in the form of mobile computing devices, comprising portable computer systems 210 capable of connecting to a network 107 and running applications. Such mobile computing devices are sometimes referred to as smartphones, although many mobile phones not so designated also have these capabilities. Tablet computers are another example of mobile computing devices. In embodiments, a client may be an editor for management of ordered lists of data objects, as shown in Fig. xx.

Although FIG. 1 illustrates three clients 103 and two servers 105 as an example, in practice many more (or fewer) clients 103 and/or servers 105 may be deployed. In one embodiment, the network 107 may be in the form of the Internet. Other networks 107 or network-based environments may be used in other embodiments.

FIG. 2 is a block diagram of a computer system 210 suitable for implementing a verb-based project management system 101. Both clients 103 and servers 105 may be implemented in the form of such computer systems 210. As illustrated, one component of the computer system 210 may be a bus 212. The bus 212 communicatively couples other components of the computer system 210, such as at least one processor 214, system memory 217 (e.g., random access memory (RAM), read-only memory (ROM), flash memory), an input/output (I/O) controller 218, an audio output interface 222 communicatively coupled to an external audio device such as a speaker system 220, a display adapter 226 communicatively coupled to an external video output device such as a display screen 224, one or more interfaces such as serial ports 230, Universal Serial Bus (USB) receptacles 230, parallel ports (not illustrated), etc., a keyboard controller 233 communicatively coupled to a keyboard 232, a storage interface 234 communicatively coupled to at least one hard disk 244 (or other form(s) of magnetic media), a floppy disk drive 237 configured to receive a floppy disk 238, a host bus adapter (HBA) interface card 235A configured to connect with a Fibre Channel (FC) network 290, an HBA interface card 235B configured to connect to a SCSI bus 239, an optical disk drive 240 configured to receive an optical disk 242, a mouse 246 (or other pointing device) coupled to the bus 212 e.g., via a USB receptacle 228, a modem 247 coupled to bus 212, e.g., via a serial port 230, and a network interface 248 coupled, e.g., directly to bus 212.

Other components (not illustrated) may be connected in a similar manner (e.g., document scanners, digital cameras, printers, etc.). Conversely, all of the components illustrated in FIG. 2 need not be present. The components may be interconnected in different ways from that shown in FIG. 2.

The bus 212 allows data communication between the processor 214 and system memory 217, which, as noted above may include ROM and/or flash memory as well as RAM. The RAM is typically the main memory into which the operating system and application programs are loaded. The ROM and/or flash memory may contain, among other code, the Basic Input-Output system (BIOS) which controls certain basic hardware operations. Application programs may be stored on a local computer readable medium (e.g., hard disk 244, optical disk 242) and loaded into system memory 217 and executed by the processor 214. Application programs may also be loaded into system memory 217 from a remote location (i.e., a remotely located computer system 210), for example via the network interface 248 or modem 247. In FIG. 2, the verb-based project management system 101 is illustrated as residing in system memory 217. The workings of the verb-based project management system 101 are explained in greater detail below in conjunction with the remaining Figures.

The system for verb-based project management 101 includes a software platform designed to enable process management in the legal and other professional service industries including: management consulting, accounting, information technology, and engineering.

The system 101 provides corporate users such as law firms and other professional service organizations the capability to deliver services at a lower cost with greater awareness of the cost and profitability related to the delivery of services. The system also enables the firm to have better understanding of what services the firm delivers, the cost of those services, and who was involved in delivering and participating in any particular matter.

The system 101 provides a better understanding of the matter though the application of metadata to the matter. The metadata may include, but is not limited to:
Matter type;
Sub-type;
Area of law;
Industry;
Practice group;
Court;
Transaction or litigation size; and
Tags.

The system also has the capability of furnishing multiple descriptions for the matter. For example, in an embodiment, the descriptions may include an internal working description of the matter, a marketing description for describing the matter to the outside world, and a description of the complexities and details of the matter.

One insight underlying embodiments of the presently described system and methods is that most projects, for example legal matters, comprise a succession of procedures that may largely be represented as verb expressions—a verb followed by a sentence object. To illustrate, a legal matter, such as a lawsuit, comprises a series of actions such as “file deposition”, “defend deposition” or “file motion to compel”. Following from the first insight may be the insight that there may be a significant degree of repetitiveness to the services delivered by organizations in many professions and that projects involving delivery of these professional services may comprise a surprisingly small number of procedure types. Even a seemingly complex matter such as a major lawsuit may involve well under one hundred different procedure types. The realization that there exists a high degree of repetitiveness in delivery of professional services such as legal services opens up the possibility of a high degree of process standardization. Experienced legal professionals may estimate with a high degree of accuracy, how much content needs to be generated for a particular matter, for example how many depositions will be required for a litigation of known scope. The system allows meaningful bottom-up budgeting—a complete budget and project plan for the lawsuit may involve only a few different procedure types. In creating a bottom-up budget for a matter, a user may begin by defining one or more procedures for the matter.

The verb-based templates, in addition to being used for templating, may also be used to create a project checklist. Because the budget process and the process checklist are so tightly linked through the procedure templates, if a bottom-up budget was created using the verb-based templates, a checklist would already have been created, as the budget was being created. Additionally, if the budget was created using another methodology, verb-based templates may be used to specify a sequence of procedures and related activities for the matter, to create a checklist. The system 101 then provides feedback of hours planned in the checklist versus hours planned in the budget.

The creation of a bottom-up budget that links with the actual work in a checklist also may create the ability to link the budget and project checklist with critical date management. For example, in responding to a motion, instead of a docketing system merely calendaring a date by which the response must be filed, the activity of receiving a motion may create an entire chain of events and resulting checklists based on the receipt of the motion.

By defining a set of templates, and interrelating the templates to both budgeting and to building project checklists, integrating them as a system, the integrated system may then associate with other activities that drive events, such as receiving a motion, which then drives the checklist, creating an opportunity to actually tightly manage the entire process. Doing so allows an organization to give clients visibility into what a matter will cost, and to better allow the organization to predict the profit from any particular matter.

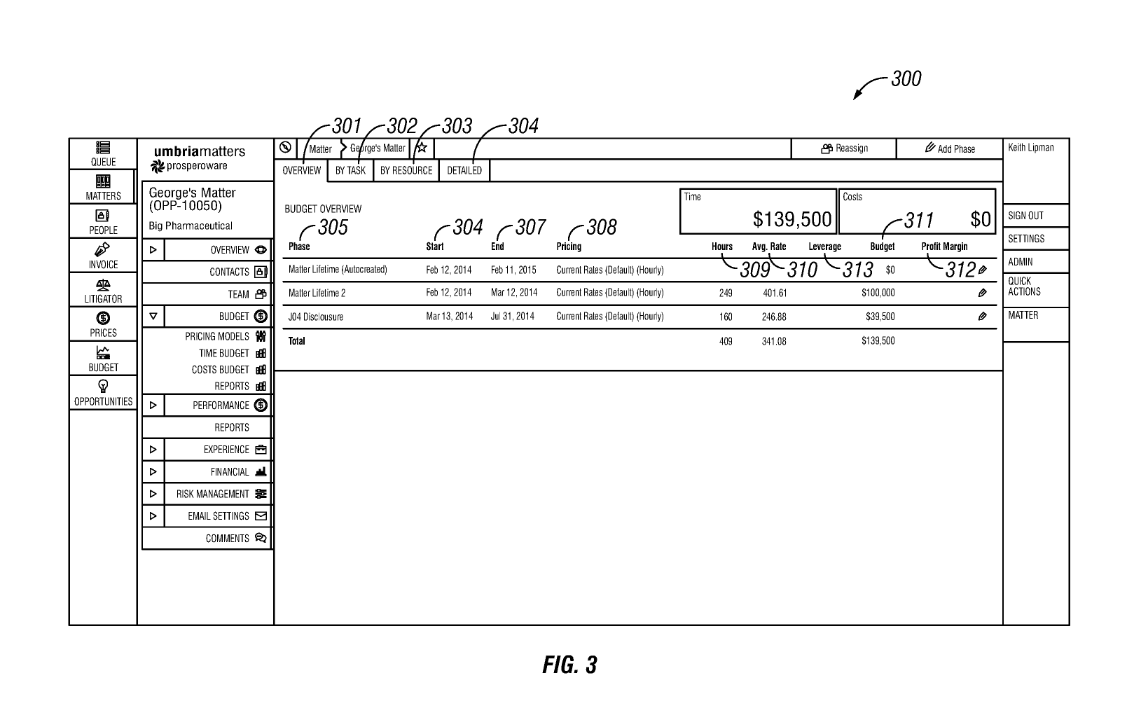

Turning now to FIG. 3, shown is a first view of a user interface (UI) 300 to a budget templating feature in a system 101 for verb-based project management. The system allows budget and activities to be closely associated. In a typical usage scenario, a user begins his or her interaction with a matter through the budget templating feature. As shown in FIG. 3, the UI 300 includes a series of tabs providing different views of the matter budget. While the ‘Overview’ tab 301 is shown selected, additionally, the UI 300 may include one or more of a ‘by Procedure’ tab 302, a ‘by Resource’ tab 303 and a ‘Detailed’ tab 304. In an embodiment, selection of any tab shows a different view of the budget organized by, for example, procedure or resource.

The exemplary budget shown in FIG. 300 includes three phases 305, each displaying a start date 306 and an end date 307 for the phase, the pricing information 308, the hours 309, the average rate 310, the total budget 311 and the profit margin 312 and leverage 313 for each phase 305. The foregoing description is not intended to be limiting. Other embodiments may include more or fewer or different features than those shown in FIG. 3. The number of phases in the exemplary budget is not intended to be limiting.

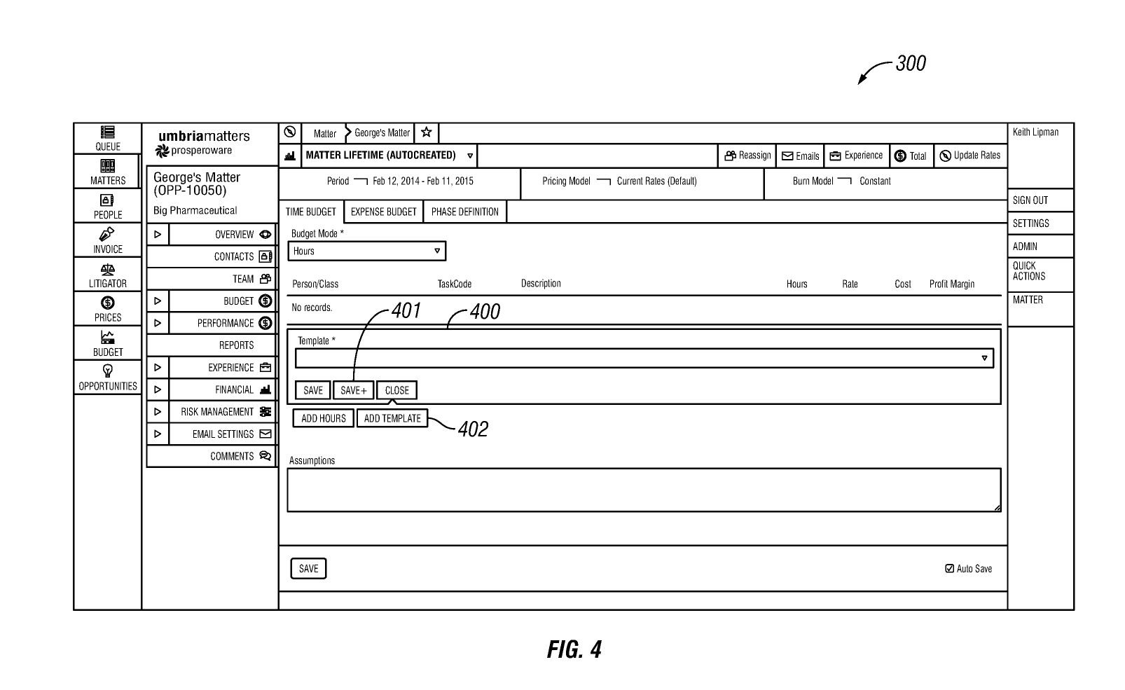

As above, a budget may be built either by defining templates for the budget or by reusing previously-defined templates. FIG. 4 shows a view of an ‘add-template’ form for adding hours to a time budget in a budget editor of the UI 300. The form includes a field 400 for defining a filter to be used in searching previously-defined templates. After being defined, the filter itself may be saved for reuse by selecting a ‘Save’ button 401.

After the filter has been applied to the store of previously-defined templates, the user may select one or more templates to be applied to the current matter. Templates may be added to the matter by way of an ‘add template’ button 402.

The ‘time budget’ tab 401 is shown selected while ‘expense budget’ 402 and ‘phase definition’ 403 remain unselected. Within the context of the present application, it is to be appreciated that a time budget would be the usual option selected in constructing a bottom-up budget. Alternatively, a conventional top-down budget may be constructed using the ‘expense budget’ option. For each phase of a matter, the budget editor allows a pricing model 404 to be selected. Additionally, for the phase, a burn model may be defined. Each phase included in the matter may also track and display the burn rate, which describes the speed that hours are to be billed against the phase. In an embodiment, for example, burn rates may include:
‘Constant’;
‘More in the middle’;
‘More in the beginning’; and
‘More in the end’.

In an embodiment, templates may also track and display the number of days elapsed from the start of the matter in order to quickly communicate the matter duration.

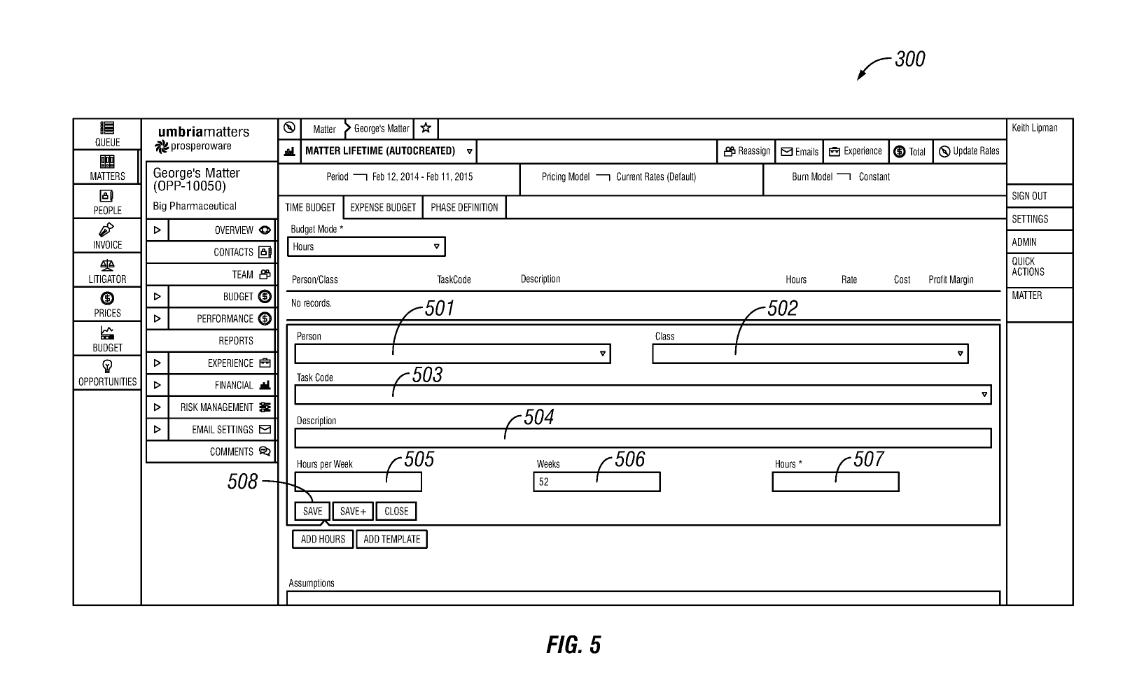

FIG. 5 shows a view of an ‘add hours’ form for defining hours anew for a matter. Hours may be defined in terms of one or more of the following parameters:
Person/class; (501, 502)—allows designation of a particular timekeeper or a timekeeper class to incur the billable hours. It will be understood that ‘timekeeper’ refers to personnel performing work and billing time on a matter. The term ‘timekeeper’ may encompass professionals such as legal practitioners, para-professionals such as paralegals as well as administrative employees whose time may be billed back to the client;
Procedure code (503)—a descriptor of the procedure for which the hours are to be incurred. In an embodiment, the descriptor may be an alphanumeric expression;
Description (504)—a narrative description of the procedure;
Hours per week (505)—the number of hours to be billed;
Number of weeks (506) and
Total hours (507).
   Once defined, the hours may be added to the matter by selecting the ‘Save’ button 508.

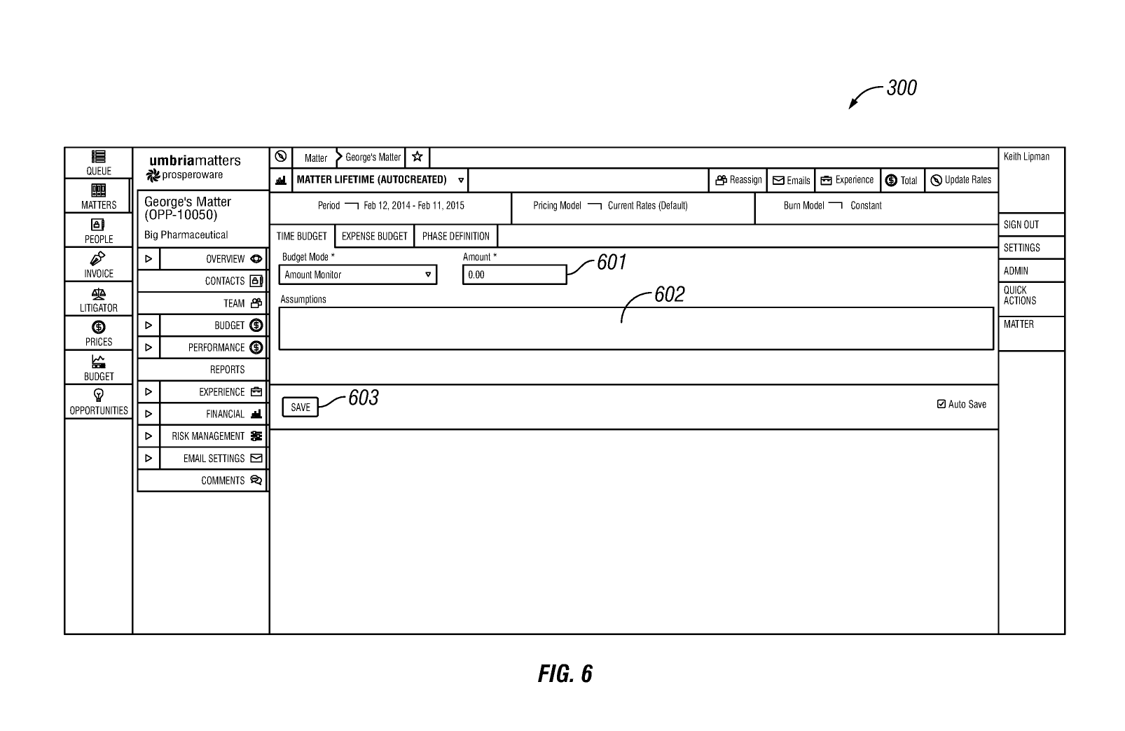

FIG. 6 shows a form for specifying a budget amount. The amount entered serves both as a cap on the hours entered as the budget is being built and on actual hours billed for the matter as the work is being completed. A numerical amount may be entered into the field 601 and the currency in which the amount may be expressed is configurable. An ‘assumptions’ field 602 allows the user to record any assumptions that were made in arriving at the amount entered. The amount may be saved by selecting the ‘Save’ button 603.

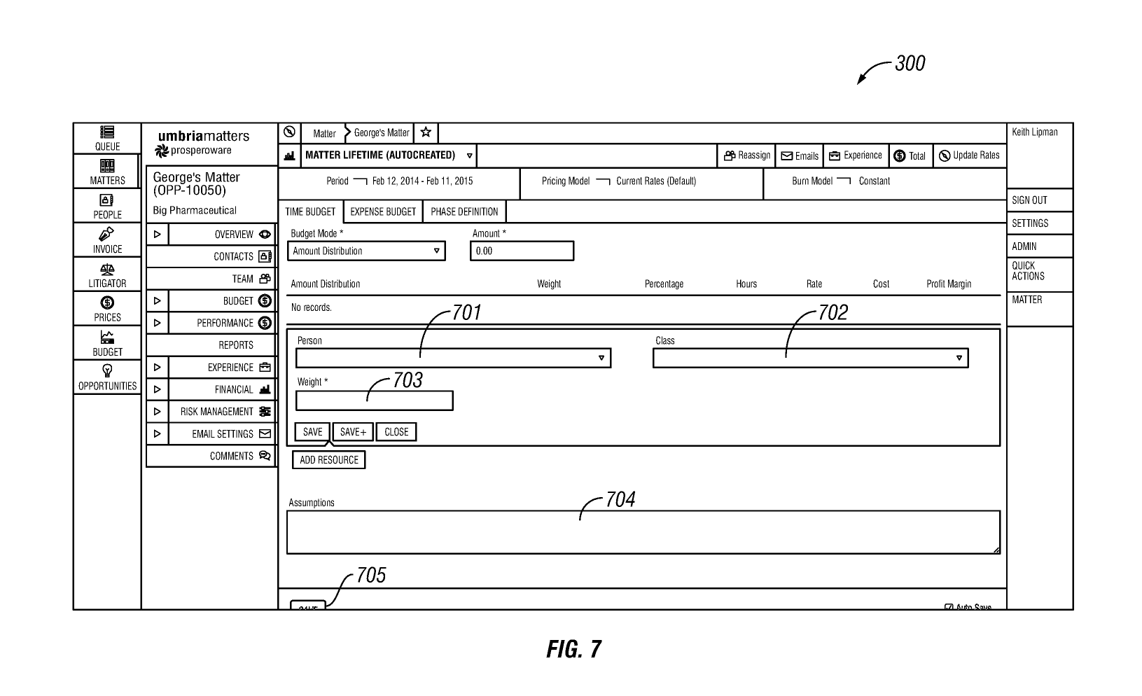

FIG. 7 shows a form for specifying an amount distribution. The amount distribution mode allows the user to specify how an allocated amount is to be apportioned between the timekeepers assigned to the matter. A specific timekeeper may be identified 701 or a particular class of timekeeper 702. For each defined entity, either person or class, a weight 703 defines the portion of the budget to be allocated for hours billed by that entity. For example, a person/class having a weight of 20 may be allocated 20% of the available budget for the particular phase or procedure or activity. A person/class having a weight of 30 may be allocated 30% of the available budget. Assumptions in arriving at the amount distribution may be entered 704 and the record saved by selecting the ‘Save’ button 705.

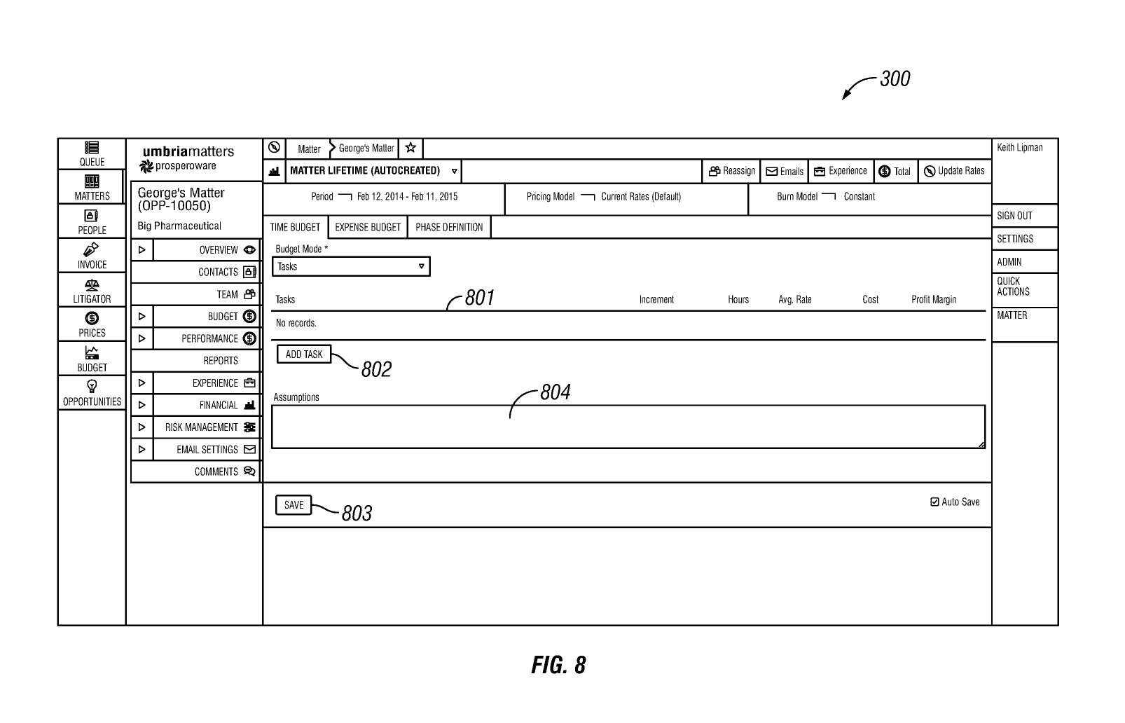

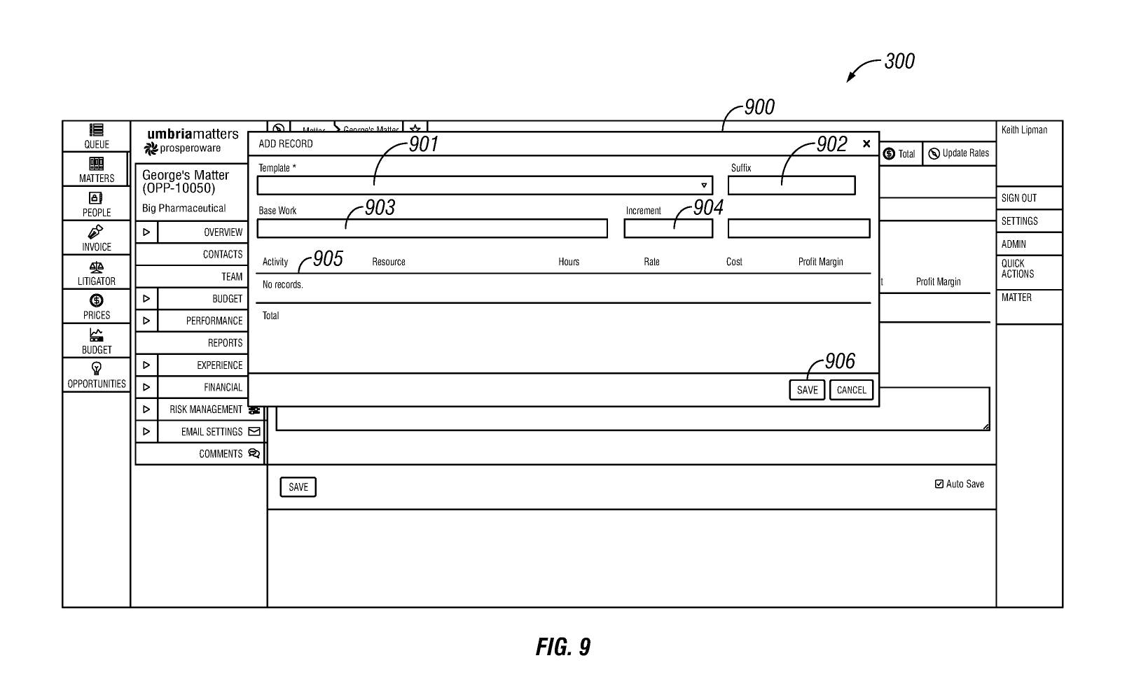

FIG. 8 shows a page for viewing and adding procedures to a budget. It will be remembered that, within the context of the present application, the procedure is the fundamental building block of a budget or project. In embodiments, as they are created, procedures may be associated to one or more phases. As shown in FIG. 8, a list 801 of the procedures already added to the budget may be displayed. If a user desires to add a procedure, the user may do so by selecting the ‘Add procedure’ button 802, whereupon he or she may be navigated to an ‘Add procedure’ screen (FIG. 9). The user may document assumptions 804 underlying the procedure, and once the procedure has been added, the user may save the change by selecting the ‘Save’ button 803.

FIG. 9 shows a view of an ‘Add procedure’ screen 900. In embodiments, the ‘Add procedure’ screen 900 may include at least one of the following fields:
Template (901). The ‘Template’ field 901 receives—and displays—the name of a procedure. Procedures are defined in terms of a verb expression, for example, “protect definition”. The template thus bears the name of the particular procedure represented by a procedure object. When a user creates a new procedure, the ‘Template’ field receives the name of the new procedure. Alternatively, the ‘Template field’ may display a listing of templates from which the user may select. After selecting a template, the user may edit the template by entering new data in any of the fields below;
Suffix (902);
Base work (903)—in an embodiment, the base work may be the total number of hours budgeted for an activity, a procedure, a phase, or for an entire matter;
Increment (904)—an increment represents the amount of hours that subsequent units of work are forecast to take;
Activity (905)—In embodiments, one or more activities are ordinarily associated to a procedure. The ‘Activity’ field 905 displays a list of the activities which make up the procedure. More will be said about activities herein below.
   Additionally, the ‘Name’ field may be edited.

After the procedure is fully defined, selection of the ‘Save’ button 906, saves the procedure.

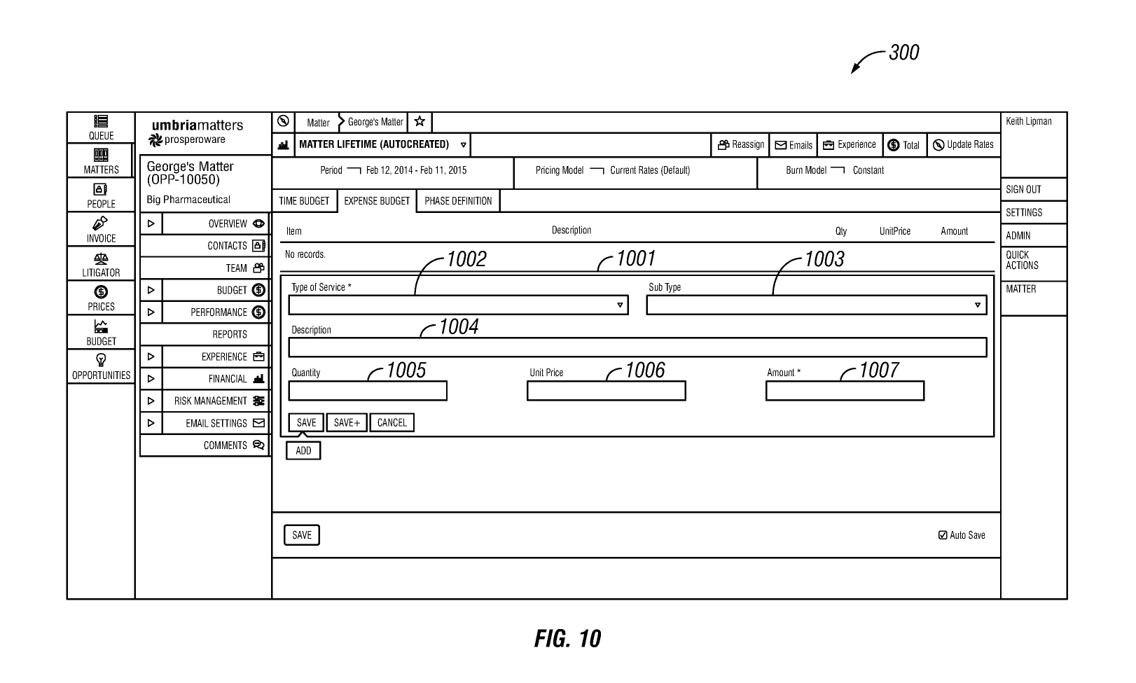

A budget for a legal matter includes not only the costs incurred for time billed by the various timekeepers working on the matter, but for expenses incurred during the matter. It has been a common practice, in the legal world, for example, for all expenses that are incurred during the lifetime of a matter to be paid through disbursements by the law firm. The law firm then bills back to the client for the disbursements. More recently, it has become commonplace for the client to pay many of the expenses directly. Nonetheless, the law firm may still be tasked with monitoring and managing expenses. In addition to constructing and monitoring a time budget, the system 101 also provides the capability of estimating and monitoring expenses over the course of a matter lifetime. Referring now to FIG. 10, shown is a page for adding expenses to a budget. The expenses being added may be for the purpose of estimating expenses at the time the budget is first being created, or for adding expenses that come up as the matter proceeds. The expenses may be either those billed directly to the organization or those billed to the client or other parties associated with the matter and reported to the organization.

The page includes a form 1001 for defining a service according to at least one of the following parameters:
‘Type of service’ (1002);
‘Sub-type’ (1003);
‘Description’ (1004);
‘Quantity’ (1005);
‘Unit prices’ (1006); and
‘Amount’ (1007).

Thereafter, the expense may be saved and added to the expense budget.

It has been mentioned before that a matter may include one or more phases. For example, conventionally, a typical lawsuit is often said to have five phases, more or less—pleadings, written discovery, oral discovery, motions and mediation and trial. Within the context of the present application, a matter may also be divided into phases, which may or may not correspond to the phases just named. In various embodiments, the phases may be differently named, or they may be of finer or coarser granularity than the phases just named. Because procedures are ordinarily associated to phases, in a typical use scenario, it makes sense to define the phases for a matter before the procedures are defined. However, the system provides no limitation in this regard. It is perfectly workable within the context of the system 101 to define a series of procedures and, thereafter, associate the procedures with one or more phases. It is to be appreciated that definition of phases may be driven by a templating function, just as it is with procedures and activities. In creating a new budget, the user may construct a group of project phases or may create a copy of an existing collection of phases from a template or an existing matter. The use of a templating function to define phases facilitates the practice of creating “phase sets”. For example, using templates, the creation of a “litigation phase set” that could be used over and over and slightly modified according to the needs of the particular matter is greatly simplified.

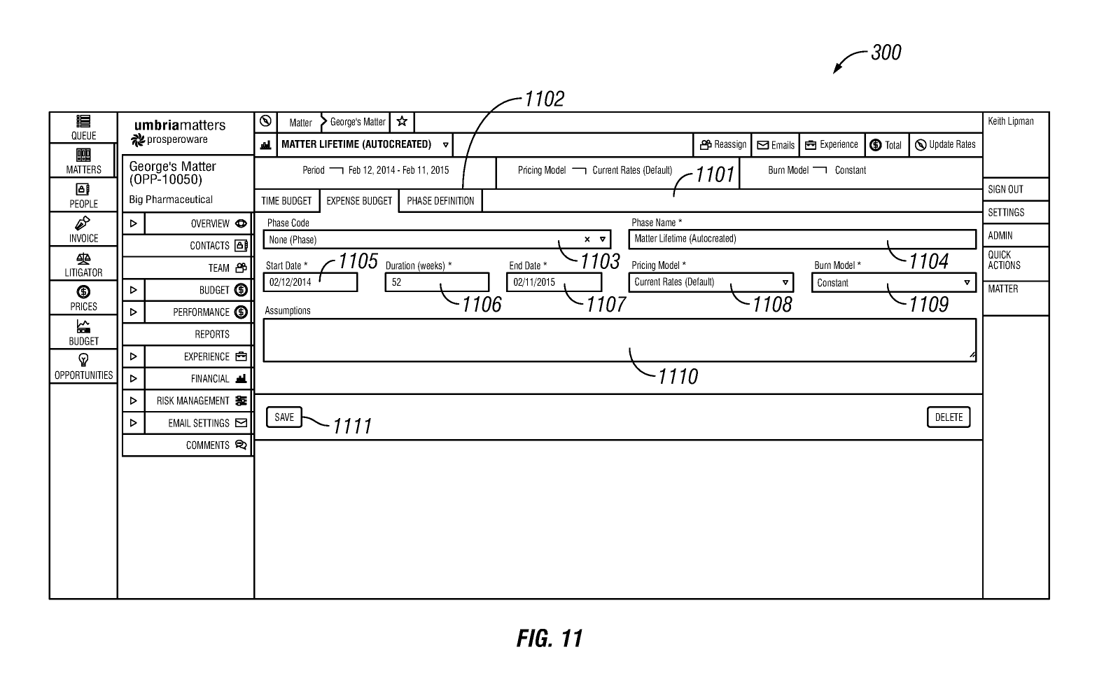

Turning now to FIG. 11, shown is a form 1101 for defining a phase, which may be accessed by selection of a ‘Phase definition’ tab 1102. In embodiments, a phase may be defined using at least one of the following parameters:
‘Phase code’ (1103)—in embodiments, a phase code may be a descriptor, selected, for example from a pre-defined listing of phase codes. In an embodiment, the descriptor may be an alphanumeric descriptor;
‘Phase name’ (1104)—in embodiments, the phase name may be a narrative name for the phase. In embodiments, the phase name may also be selected from a pre-defined listing of phase names. Additionally, particularly in the case of atypical matters, the phase name may be generated ad hoc;
‘Start date’ (1105);
‘Duration’ (1106)—while customary practice is to define a phase duration in weeks, the system 101 provides several additional alternatives as well;
‘End date’ (1107);
‘Pricing model’ (1108)—billable hour is the most conventional pricing model, but embodiments provide for alternative pricing models, such as fixed fee;
‘Burn model’ (1109)—burn model was described herein above; and
‘Assumptions’ (1110).
   After a phase is created, it may be saved 1111. Additionally, a phase may be deleted 1112 from a matter.

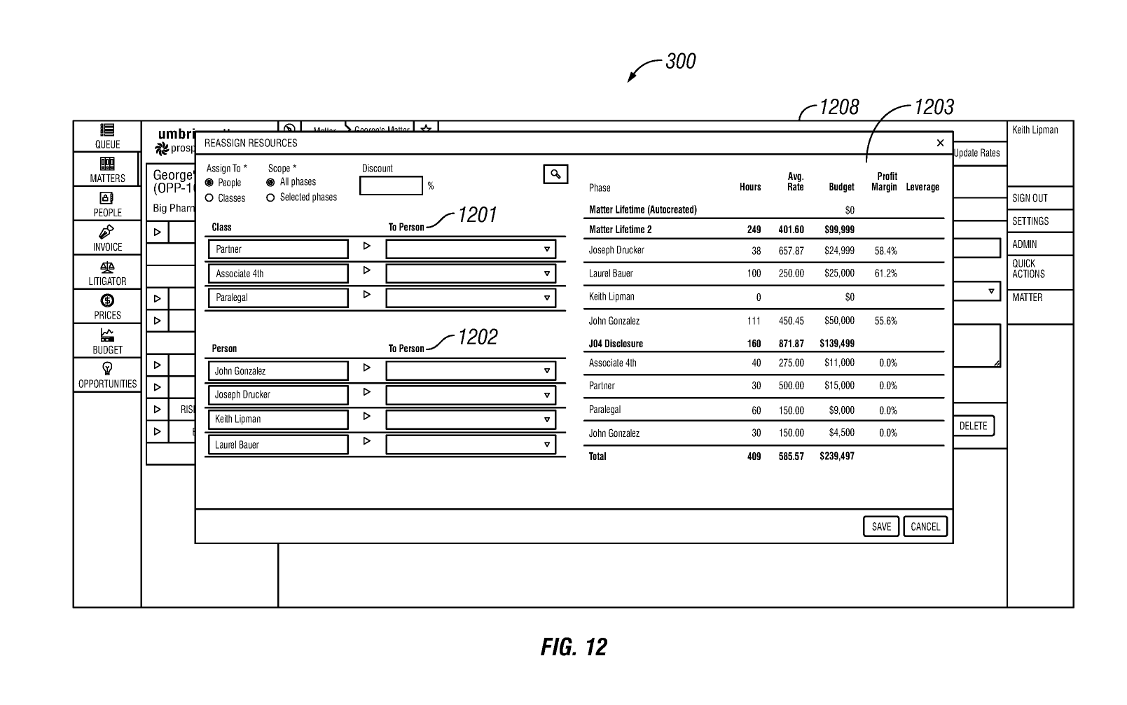

Referring now to FIG. 12, shown is a form for re-allocation of resources. As described in relation to FIG. 5, as a budget is being created for a matter, specific timekeepers or specific types of timekeeper may be assigned to various portions of a matter, either for a phase, a procedure or an activity. The form shown in FIG. 12 permits a user to reallocate the human capital assigned to a matter in a number of ways. For example, the form 1200 provides one or more fields 1201 for changing an assignment from being an assignment of a particular timekeeper class to being an assignment of a particular timekeeper. Additionally, the form 1200 includes one or more fields for changing an assignment from being an assignment of a first timekeeper to assignment of a second timekeeper. In a further embodiment, the user may be able to change the assignment from being of a particular timekeeper to being an assignment of a particular timekeeper type (not shown). As resources are reassigned, the display 1203, listing the personnel assignments, the rate and the profit margin automatically update in real time to reflect the change in personnel.

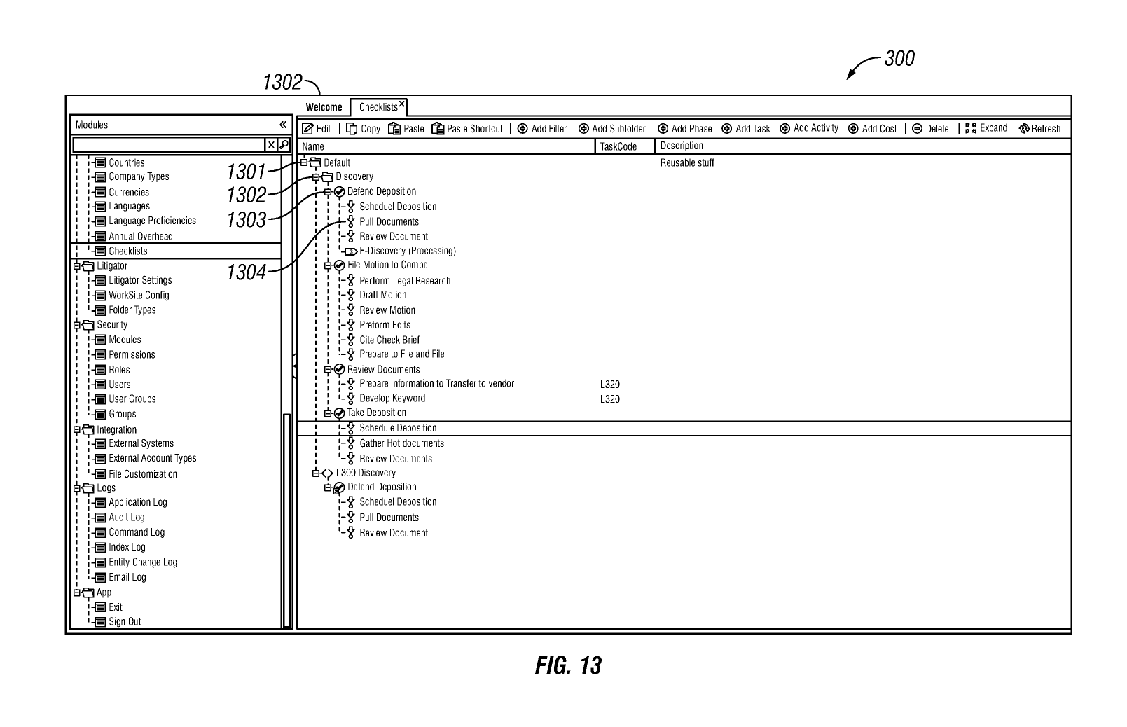

While the preceding FIGS. 3-12 displayed various features and aspects of a budget editor portion of the UI 300, the UI 300 also includes an ‘Administrative’ section which displays the matter organized as a project checklist 1300. In embodiments, as shown in FIG. 13, the project checklist may be displayed as a nested list of matter components to reflect the hierarchy of matter 1301→phase 1302→procedure 1303→activity. Displaying the matter organized as a checklist reflects the strong affinity felt by practitioners in certain professional fields, such as legal practice, for using checklists as tools for managing their work efficiently. Providing the two views of a matter, budget editor and project checklist reflects the design imperative of closely associating activities to budget in order to provide transparency and extremely fine-grained budget management.

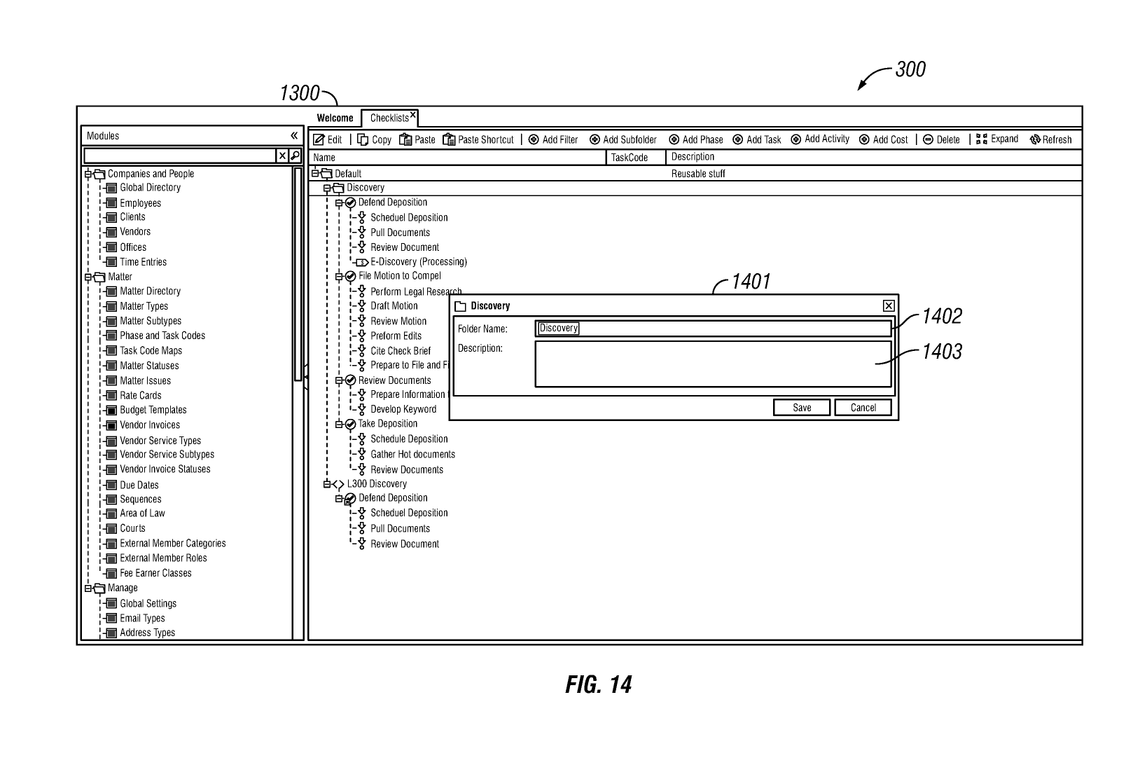

Turning now to FIG. 14, shown is a form 1401 for adding a phase to a matter checklist 1300. Using form 1401, the user may create a folder for the phase, name it 1402 and provide a description 1403. Once created, the user may use the budget editor, as shown in FIG. 11, to create a detailed phase definition. In embodiments, the form 1401 may also provide the capability of completely defining a phase as shown in FIG. 11.

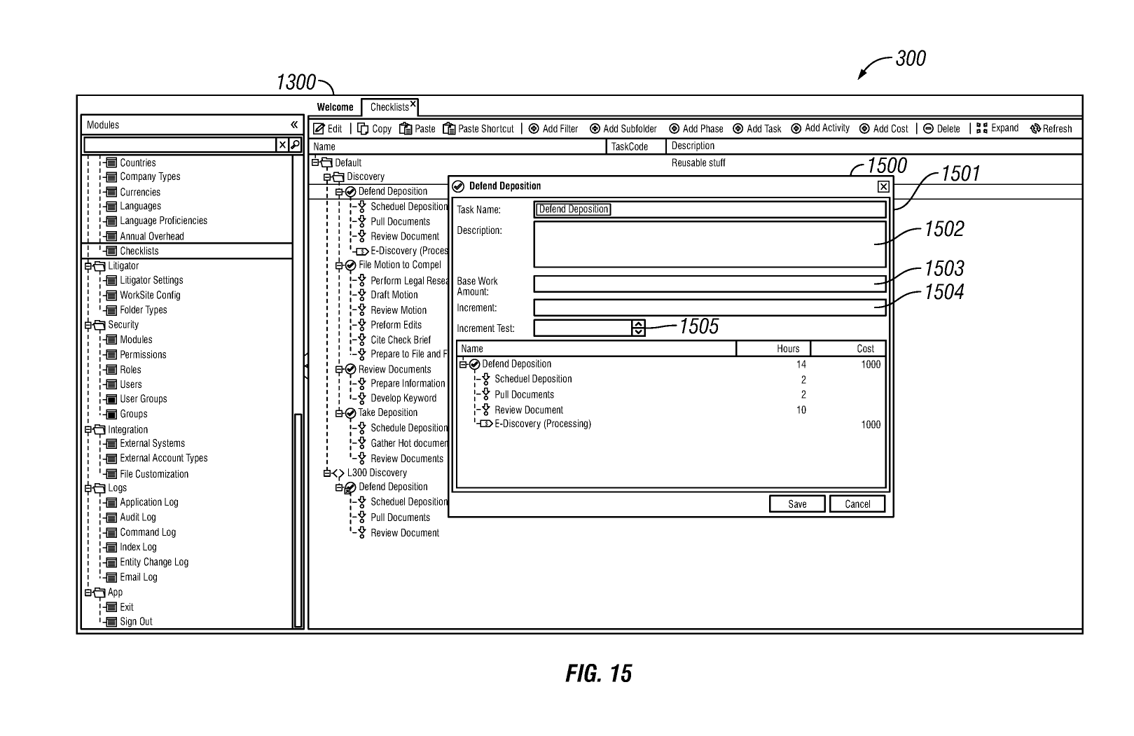

FIG. 15 shows a form 1500 for adding a procedure to a phase within a matter checklist 1300. In embodiments, the form 1500 includes at least one of:
a ‘Procedure name’ field 1501;
a ‘Description’ field 1502;
a ‘Base work amount’ field 1503;
an ‘Increment’ field 1504; and
an ‘Increment test’ field 1505.

The practitioner of ordinary skill will readily recognize that the procedure for adding a procedure to a phase from within the project checklist may be a close analog of the process described in relation to FIGS. 7-8.

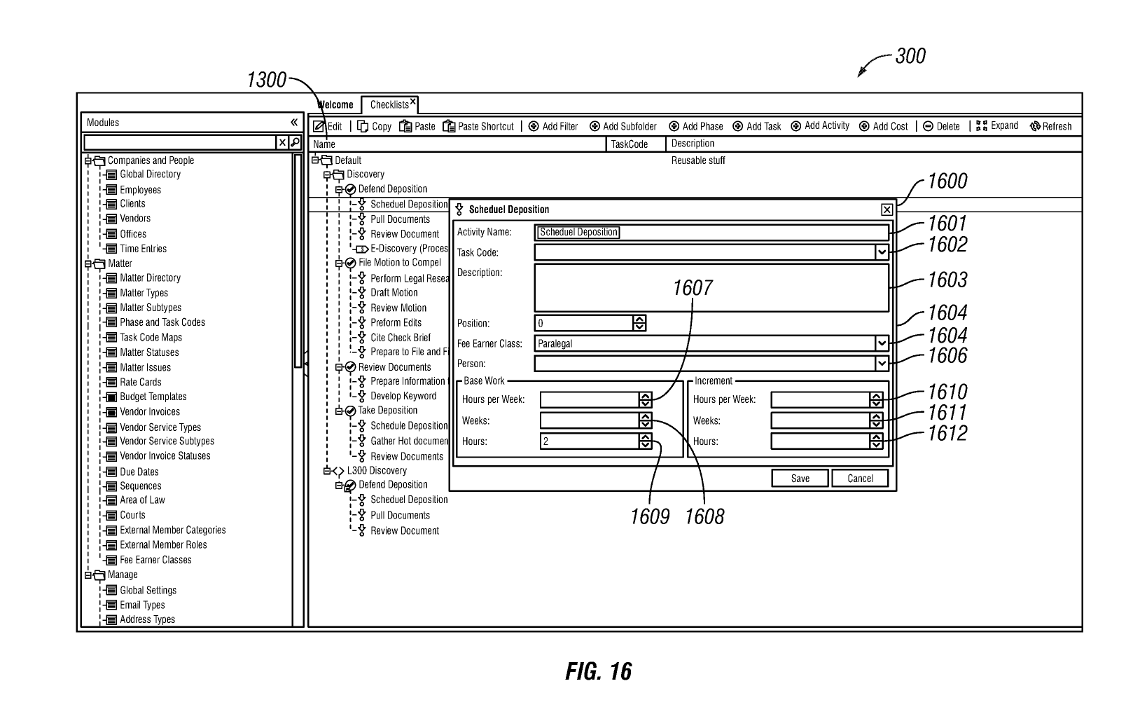

FIG. 16 shows a form 1600 for adding an activity to a procedure from the project checklist. In embodiments, the form 1600 provides at least one of the following fields:
‘Activity name’ 1601;
‘Procedure code’ 1602;
‘Description’ 1603;
‘Position’ 1604;
‘Fee earner class’ 1605
‘Person’ 1606
‘Base work: Hours per week’ 1607;
‘Base work: Weeks’ 1608;
‘Base work: Hours’ 1609;
‘Increment: Hours per week’ 1610;
‘Increment: Weeks’ 1611; and
‘Increment: Hours’; 1612.

Although not previously shown, in embodiments, the budget editor provides a functionality that may be a close analog of that shown in FIG. 16.

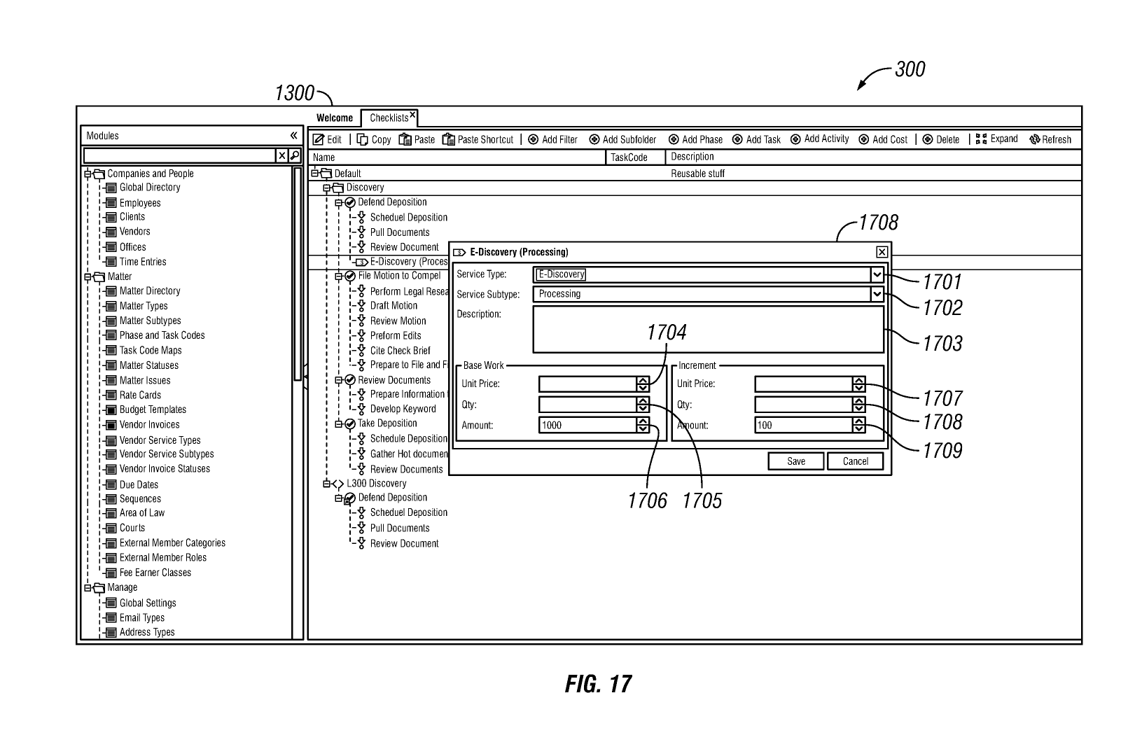

FIG. 17 shows a form 1700 for adding a cost to procedure. In embodiments, the form 1700 may include at least one of the following fields:
‘Service type’ 1701;
‘Service subtype’ 1702;
‘Description’ 1703;
‘Base work: Unit price’ 1704;
‘Base work: Quantity’ 1705;
‘Base work: Amount’ 1706;
‘Increment: Unit price’ 1707;
‘Increment: Quantity’ 1708; and
‘Increment: Amount’ 1706.

The ordinarily-skilled practitioner will readily recognize that adding a cost in the budget checklist may be a close analog of adding a service in the budget editor, as shown in FIG. 10.

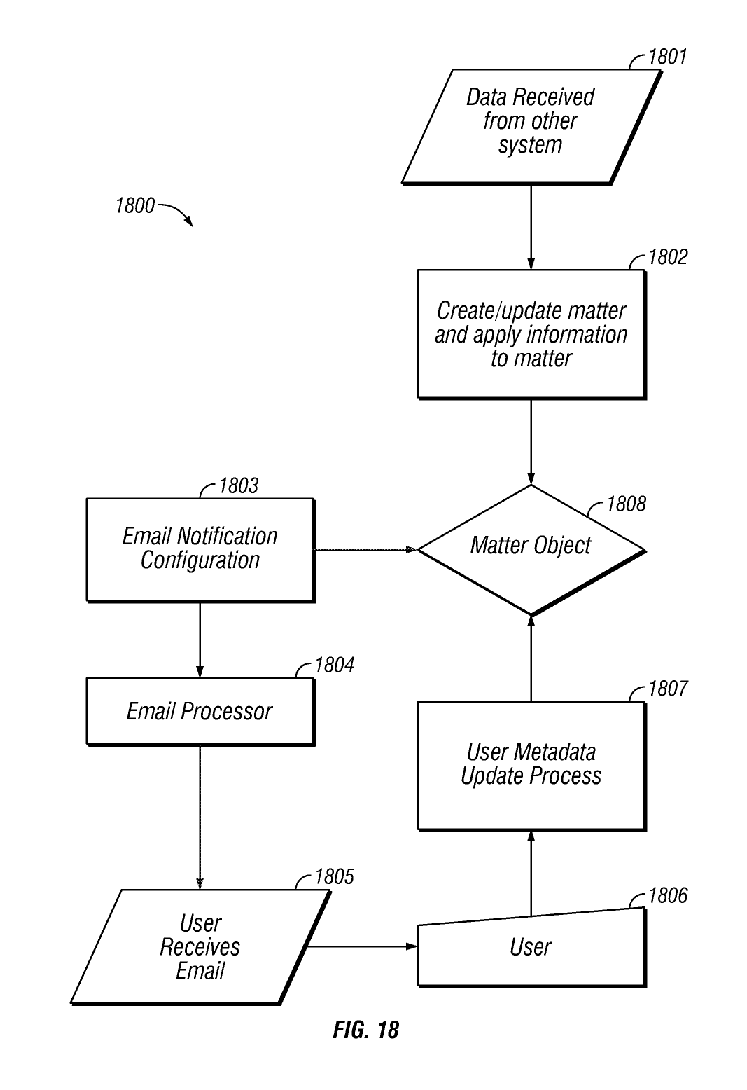

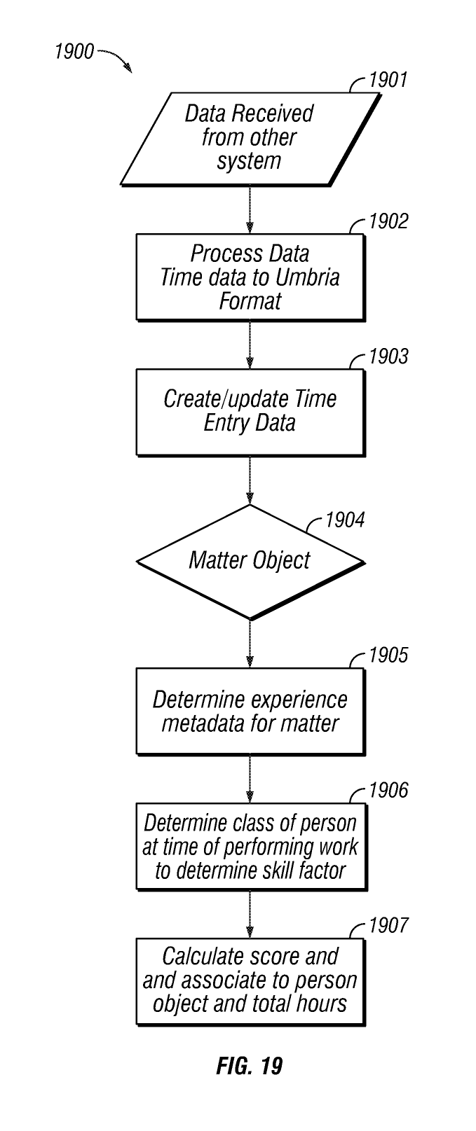

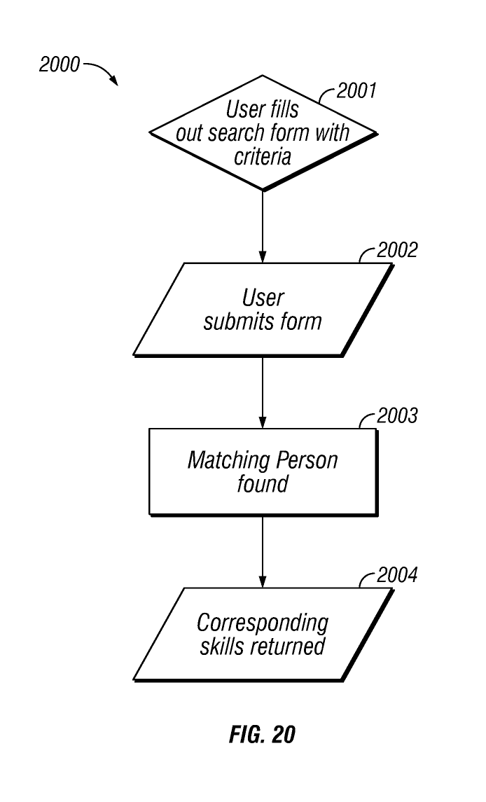

Referring to FIG. 18, shown is a flow diagram of a process 1800 for building an experience store for experience scoring. As shown, the process 1800 may include at least one of the following steps:
receive data from another system (1801);
create/update the matter and apply the information from the other system to the matter (1802);
configure a user email notification (1803;
submit the configured email notification to an email processor (1804);
a user receives the email notification (1805);
the user furnishes data to the system (1806);
the system updates the user metadata based on the data furnished by the user (1807); and
the metadata for the matter object may be updated (1808).
   Referring to FIG. 19, shown is a flow diagram of a process 1900 for applying experience scoring to a person that includes at least one of the following steps:
receive data from another system (1901);
process time data to the native system format (1902);
create/update time entry data (1903);
associate the time entry data to a matter object (1904);
determine experience metadata for the matter (1905);
determine class of person at time of performing work to determine skill factor (1906); and
calculate score and associate to person object and total hours (1907).
   Referring to FIG. 20, shown is a flow diagram of a process 2000 for finding a person having a predetermined background of experience that includes at least one of the steps of:
user fills out a search form with criteria (2001);
user submits filled-out form (2002);
person is found that satisfies the criteria (2003); and
corresponding skills are returned (2004).

The system gathers experience information by sending emails on a regular basis to the individual responsible for delivering of the services related to engagement. These emails show what has been set as experience for the matter and allow the user to update it.

The system 101 also provides a mechanism to import data from the service firm's existing system. These systems may include, for example, time & billing/practice management/financial systems, document management, conflicts management, and Customer Relationship Management. In an embodiment, the key legacy system from which data may be absorbed is the legacy time & billing system.

By importing time and billing data for each matter and providing additional metadata enhancement, the system 101 may give a user the ability to search for matters similar to each other and to understand the cost of providing the service or services associated to that matter type. This may include the firm's fees or revenue and the expenses related to the matter, with appropriate key performance indicators such as the profitability of the matter, leverage (ratio of partners to associates), and realization (comparison of fees received versus hours billed at the current rates in effect at the time).

Through the linkage of people/companies to matters, the system 101 allows experience and expertise to be tracked and reported. The people may either be employees or partners of the firm or they may be externally related to the firm such as clients, judges, vendors, employees of clients, opposing parties, or potential clients.

In embodiments, the system allows an organization to track the metadata with which the matter is defined and the accumulated experience associated to any particular set of metadata, on a practitioner basis. For each hour entered, the system 101 may multiply the total hours billed by an experience rating. In an embodiment, the experience score may be developed against the metadata that includes, for example, matter type, sub-type, area of law and tags. The experience rating may be determined by an administrator, with less experienced individuals receiving a lower multiplier than a person with greater experience. These scores may be used to determine which individuals in the firm have the greatest experience on a particular topic. The experience score may also be used to suggest who would be the most qualified individual to staff a matter. Thus, an organization, when associating metadata to experience, is enabled to easily rank the experience of any particular individual relative to any particular matter type—to define an experience profile for any practitioner within an organization.

In embodiments, the quality of any practitioner's experience may be ranked. To illustrate, in a particular matter, a first-year associate may do ten hours of work on a matter. Because the first-year's level of expertise may be relatively low, the ten hours of work may be given a rank of 0.9, meaning that the ten hours of work are ranked as representing nine hours of experience. A partner, on the other hand, as a result of his or her expertise and years of expertise, may have a rank of 2.0, so that 10 hours of work billed to a matter may be ranked as 20 hours of experience for that particular type of matter.

The metadata with which a matter may be defined: matter type, sub-type, area of law, industry, practice group, court, transaction or litigation size, etc. combined with the tags that may further describe the matter, also constitute a description of the type of exposure any significant block of experience represents. As an example, the metadata for a matter may be ‘litigation; litigation, employment discrimination; area of law—employment’; with tags specifying, for example ‘sexual, inappropriate conduct’, ‘inappropriate pictures’—a ranking of the hours of experience worked by a practitioner on a representative case, allows the organization to quantify and assess the practitioner's experience in an extremely fine-grained manner. With such a comprehensive picture of the practitioner's experience, the organization may be enabled to gain maximum leverage from the practitioner's experience.

Additionally, associating a person's experience with metadata allows the organization to determine which of their practitioners has particular industry experience.

Identifying people having the right experience is a perennial challenge for professional services organizations. Because the system has the capability of tracking the experience of almost any type of person associated with the organization—consultants, vendors, judges, regulatory officials, etc., in addition to those employed by the organization, the system provides a professional services organization with an extremely efficient way to source human capital having the right qualifications on a just-in-time basis.

Additionally, by assigning particular people to particular stages of a matter, a phase or a particular procedure for example, the system gives an organization the ability to closely monitor availability of their personnel: who's available, who's not available, who's expected to be busy, and who's not. By building checklists and budgets to plan matters, the organization may be able to predict when any particular individual practitioner will be available or unavailable, thus facilitating a much more dynamic organization.

The system 101 also provides the capability of estimating profitability based on direct and indirect costs. For example, each timekeeper's salary may be divided by his or her target or actual billable hours. Indirect costs, such as overhead, may be calculated by assigning each timekeeper a point score. In an embodiment, for example, an associate may be assigned a point value of 1 and partners a point value of 2. The total overhead at firm, office or practice area level may then be calculated as the total number of points which may then be divided by the total target or actual billable hours for all timekeepers, which provides a cost per point. For each timekeeper, the system 101 may then calculate an indirect cost per hour by multiplying the point cost by assigned points for that person. For each hour, the sum of the direct overhead costs and indirect costs may be used to calculate a profit margin for the system 101.

When one or more exemplar matters have been identified that appear to be similar to a new opportunity, a user may use the total fees and expenses and the staffing model of the exemplar to create a budget for the matter.

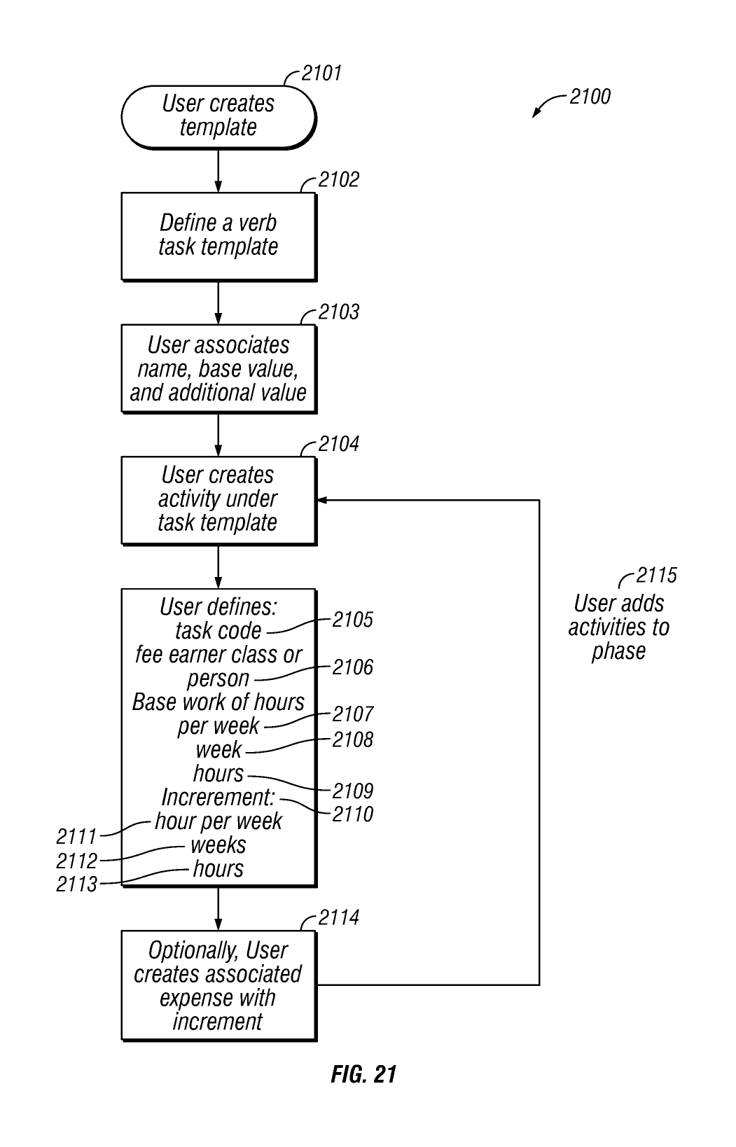

Referring to FIG. 21, shown is a flow diagram of a process for defining a verb-based template that includes at least one of the following steps:
user creates a template (2101);
user defines a verb proce333333333333333333333dure template (2102);
user associates a name, base value and, optionally, an additional value with the template (2103);
user creates an activity under the procedure template (2104);
user defines:
   procedure code (2105);
   fee earner class or person (2106);
   Base work of hours per week (2107);
   week (2108);
   hours (2109);
   increment (2110):
      hour per week(2111);
      weeks (2112);
      hours (2113);
optionally, user creates an associated expense with an increment (2114); and
the user iteratively adds activities to the phase as they are created (2115).

Procedures may be grouped into logical collections or in phases. These groupings of procedures and/or phases may be further described using appropriate metadata; for example, matter type, area of law, matter sub-type and country. This enables the system 101 to display the appropriate available procedures based on the opportunity's metadata and allows the user to create the budget from the bottom up. The procedure, in addition to including effort, may provide template expenses.

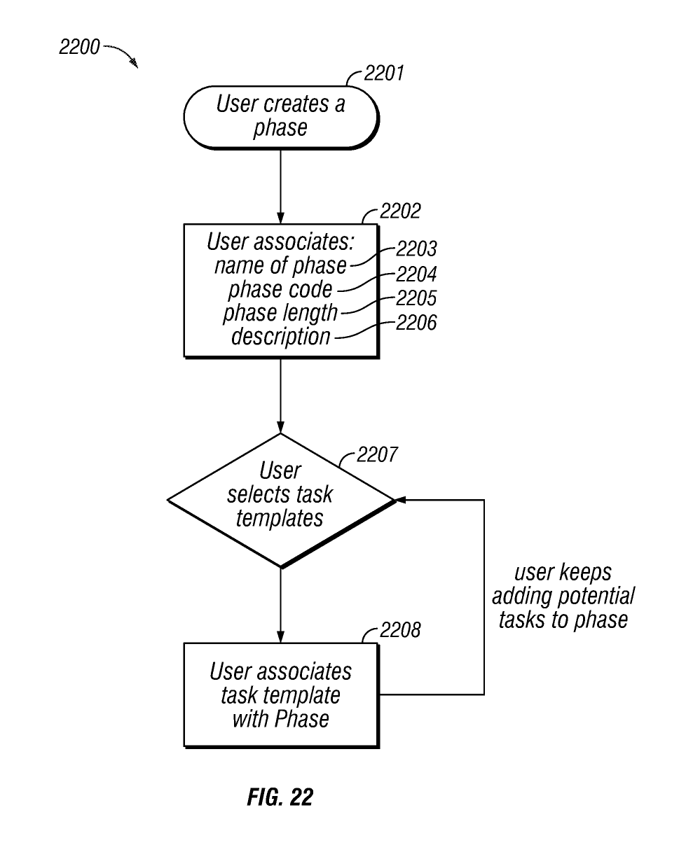

Referring to FIG. 22, shown is a flow diagram of a process 2200 for grouping verb-based templates, based on phases, which includes at least one of the steps of:
user creates a phase (2201);
user associates (2202):
   name of phase (2203);
   phase code (2204);
   phase length (2205);
   phase description (2206);
user selects procedure templates (2207);
user associates selected procedure to the phase (2208); and
user iteratively adds potential procedures to the phase (2209).

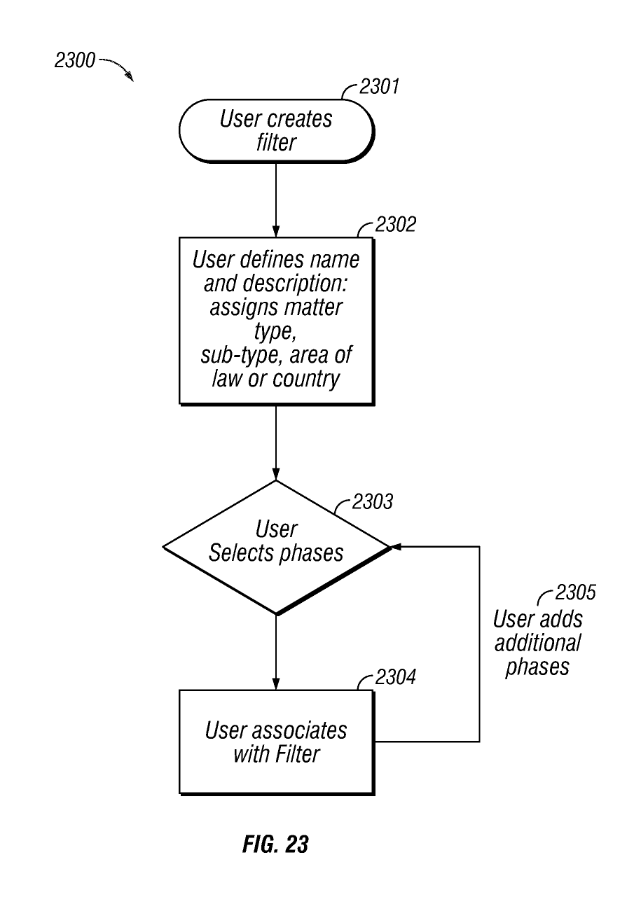

Referring to FIG. 23, shown is a flow diagram of a process 2300 for grouping phases using filters that may include at least one of the following steps:
user creates a filter (2301);
user defines name and description, assigns a matter type, sub-type, area of law or country (2302);
user selects phases (2303);
user associates phase with the filter (2304); and
user iteratively adds phases (2305).
   A budget may be determined using one or both of two methods:
a top-down calculation; and
a bottom-up estimation of the effort to be expended during the matter.

The top-down calculation typically starts with a projection of the amount of fees to be billed in the matter and a fee schedule for all timekeepers. In an embodiment, the system 101 may ask the user to specify a staffing model (associates, paralegals and partners) either by class or by specific employee or employees and the percentage of work each will perform in the matter. The system 101 may then calculate the available hours and the profitability of those services. If the hours are not sufficient, the user may input additional written or non-billable hours, which may reduce the profitability of the matter.

The bottom-up budget may be either created though the assignment of hours to a person or through a verb-based approach to budget creation. In an embodiment, the verb-based approach typically uses a template that has been previously created by, for example, an administrator. In an embodiment, the template describes a procedure and the underlying activities. It will be appreciated that the expression “verb-based” reflects that procedures and activities are assigned descriptors that constitute verb phrases. Within the context of the present application, a verb phrase is to be understood as including a verb and one or more sentence objects. For example, within the context of the present application, a procedure may be identified by a verb phrase such as “defend deposition”, the verb phrase constituting the verb “defend” and the object “deposition”. In an embodiment, the exemplary procedure “defend deposition” may include one or more activities, each identified by a verb phrase, for example: “schedule deposition”; “pull documents” and “review documents”.

For each activity, an administrator may determine a base amount of work, a timekeeper class or a particular person who will provide the work, and a procedure code. The administrator may also determine the additional time required for each additional unit. At the procedure level, the administrator may assign a descriptor for an additional unit of work and what is included in the base unit of work.

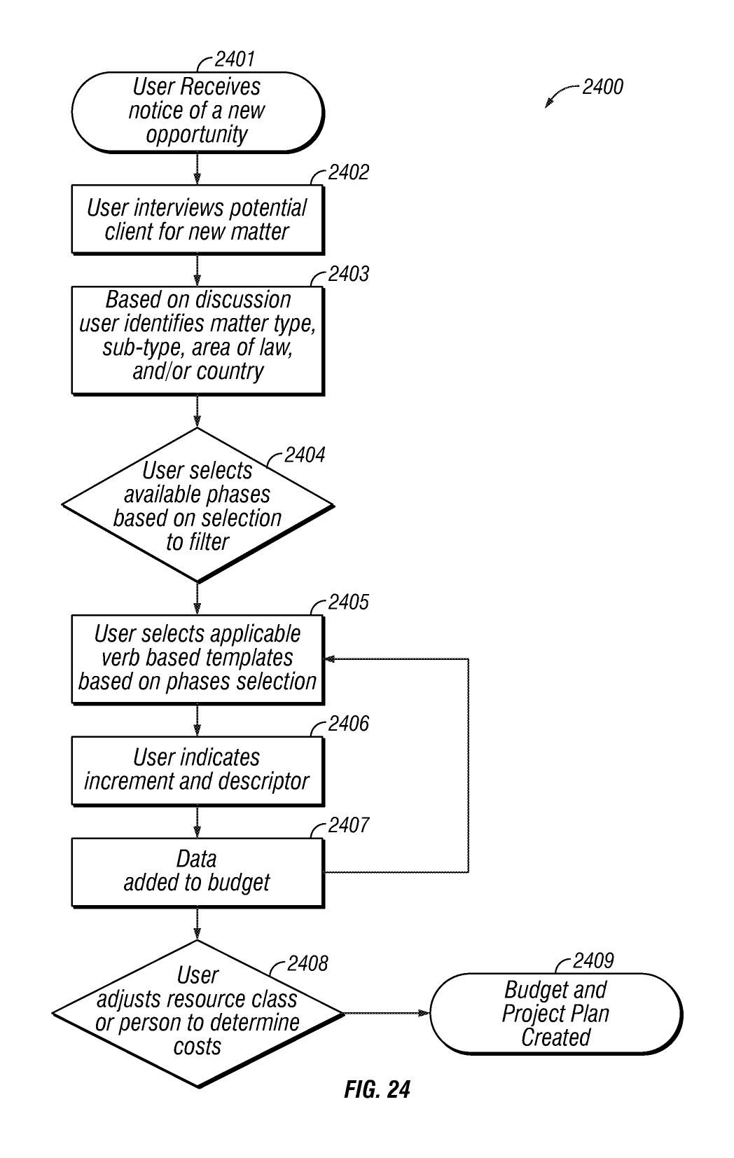

It is to be appreciated that, in actual practice, a user may develop a budget using a combination of top-down and bottom-up approaches. For example, a user, presented with a new matter, based on his or experience and expertise may arrive at an estimated net number of hours for the matter and an estimated total budget of, for example $100,000.00. After presenting that estimate to the client and receiving the client's ‘ok’ to proceed, the user may now be faced with the task of developing a detailed budget and project plan wherein the costs are closely associated tithe separate phases, procedures and activities that the matter involves. Thus, in embodiments, there may be a top-down stage of budget development which gives way to a bottom-up approach in which activities and costs are closely mapped to each other. As shown in FIGS. 24-26, an actual budget process may amalgamate top-down and bottom-up budgeting approaches.

Referring to FIG. 24, shown is a flow diagram of a process 2400 for creating a budget using verb-based templates that may include at least one of the following steps:
the user may receive notice of a new opportunity (2401);
the user may interview a potential client for the new matter (2402);
based on discussion, user selects metadata for the matter including one or more of: matter type, sub-type, area of law and/or country (2403);
user selects available phases based on selection to filter (2404);
user selects appropriate verb-based templates based on phase selection (2405);
user indicates increment and descriptor (2406);
data may be iteratively added to the budget (2407);
user adjusts resource class or person to determine costs (2408); and
a budget and a project plan are created (2409).

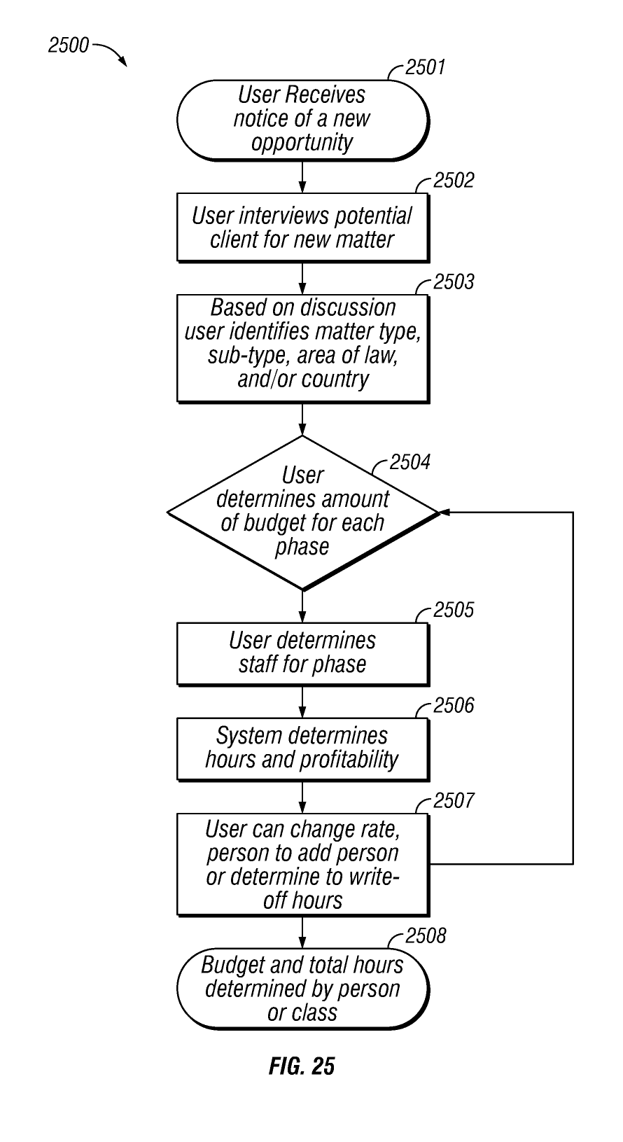

Referring to FIG. 25, shown is a flow diagram of a process 2500 for creating a top-down budget that may include at least one of the following steps:
the user may receive notice of a new opportunity (2501);
the user may interview a potential client for the new matter (2502);
based on discussion, user identifies metadata for the matter including one or more of: matter type, sub-type, area of law and/or country (2503);
user determines amount of budget for each phase (2504)
user determines staff for each phase (2505);
system determines hours and profitability (2506);
user iteratively changes rate or person to add a person or determines to write off hours (2507); and
budget and total hours are determined according to person or class (2508).

In an embodiment, the user, instead of creating a specific budget, may simply monitor a matter against a determined amount. The same reporting tools as described herein above are still available.

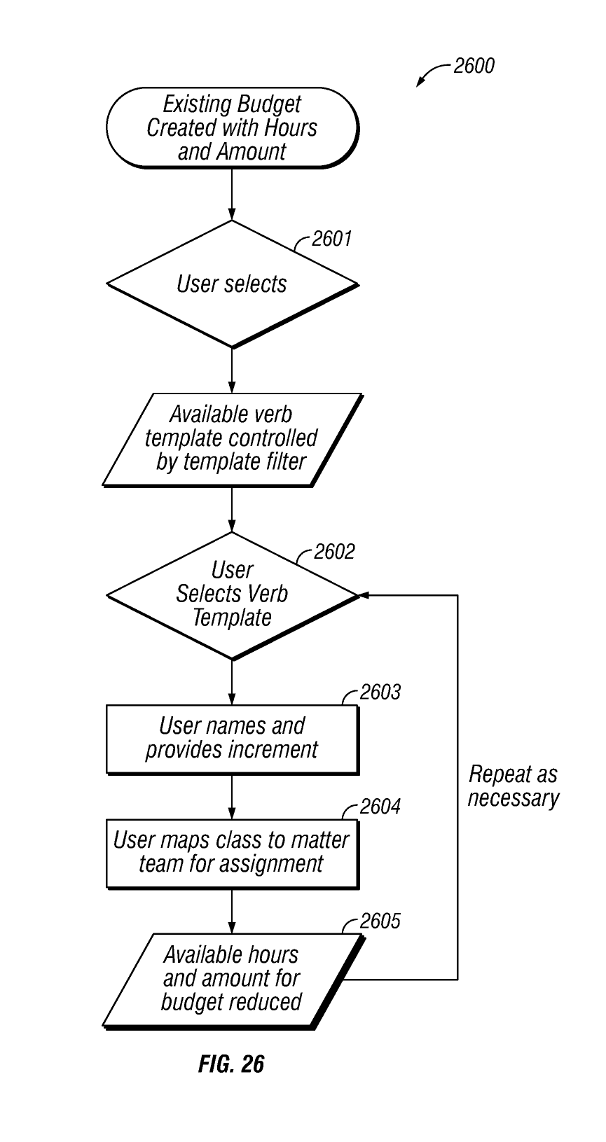

Referring to FIG. 26, shown is a flow diagram of a process 2600 for creating a budget based on verb-based templates and comparing the created budget with a pre-existing budget that may include at least one of the following steps:
user selects an existing budget with hours and amounts (2601);
user selects a verb template from a plurality of available verb templates controlled by a template filter (2602);
user names the budget and provides an increment (2603);
user maps class to matter team for assignment (2604); and
available hours and amount for the budget are iteratively adjusted to redefine the template as necessary (2605).

When a budget has been created, the system 101 monitors the matter, either through providing reporting that may be consumed directly in the application or through the delivery of email reports. In an embodiment, such reports are typically delivered on a weekly basis. However, report delivery is a configurable parameter. If any timekeeper assigned to the matter neglects to enter his or her time, the system 101 reports that time for that timekeeper has not been entered, providing the user with notice that the report may not be accurate.

The foregoing description extensively describes the use of templates in order to create and define data objects such as matters, phases, procedures and activities. It is to be appreciated that a template constitutes a data object that may be copied in whole or in part in order to create a new object that may share one or more attributes with its parent template. It will also be appreciated that any existing data object may serve as a template for a new data object. Thus because any object can serve as a template, it will be appreciated that the terms “procedure template” and “procedure object” for example, “matter template” and “matter” are substantial equivalents. Thus, to a degree, the terms are interchangeable.

Furthermore, It will be appreciated that templates are data objects and that an instantiation of a template can be modified, or edited to produce a new data object distinct from the original template object. Furthermore template objects and instantiations of template objects can be combined to form new objects. One of ordinary skill will appreciate that a procedure is a data object; an action is a data object; a phase is a data object; a document is a data object and that these objects can be associated to a matter object in an endless variety of combinations and configurations. In an embodiment, a matter object having other objects associated thereto may be considered a complex object, or a class. In embodiments, objects may be associated to a matter object using data structures such as arrays, lists and trees. One of ordinary skill will appreciate that an object itself is, in fact, a data structure that contains data fields as well as various methods which operate on the contents of the data fields.

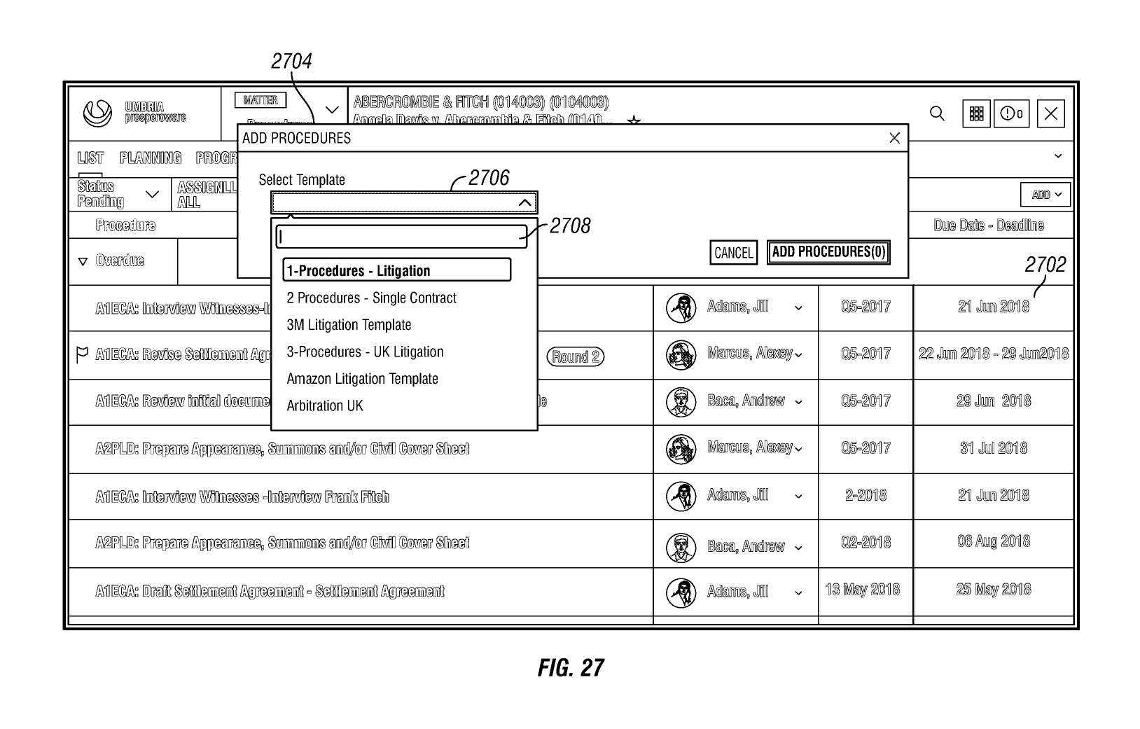

FIGS. 27-30 provide screen shots of a user interface to an editor for managing ordered lists of data objects. In embodiments, the editor may include a mobile device such as a tablet or smartphone programmed to provide a drag-and-drop user interface for managing ordered lists of data objects, as shown in FIGS. 27-30. The provision of a drag-and-drop interface to manage the lists greatly improves the ease with which a user may interact with a computational device to manage an ordered list of data objects. By using the drag-and-drop interface, a single gesture may launch a long series of instructions, most of which may not even be known to the user. If the instruction had to be individually launched by the user, it would take many minutes to deliver the commands to the computational device. Thus, the present editor provides a substantial increase in its ease and speed of use over conventional computational approaches to management of ordered lists of data objects. In addition to the drag-and-drop feature, the user is provided alternative ways of interactive with data objects, for example by clicking arrows that indicate the destination of a data object being moved.

In a similar manner, instantiations of procedure objects may be associated to the matter object. FIG. 27 shows a screenshot of a device UI 2702 for adding a procedure object 2704 to a matter object. A ‘select template’ box 2706 displays a menu of procedure objects from which the user may select. The user may select from the list by using a pointing device such as a mouse to select a procedure object to add to the matter object. Alternatively, the user, upon selecting the procedure object, may drag the procedure from the menu to a UI representation of the matter object, whereupon the process of associating the procedure object to the matter object is automatically completed without further action or intervention by the user.

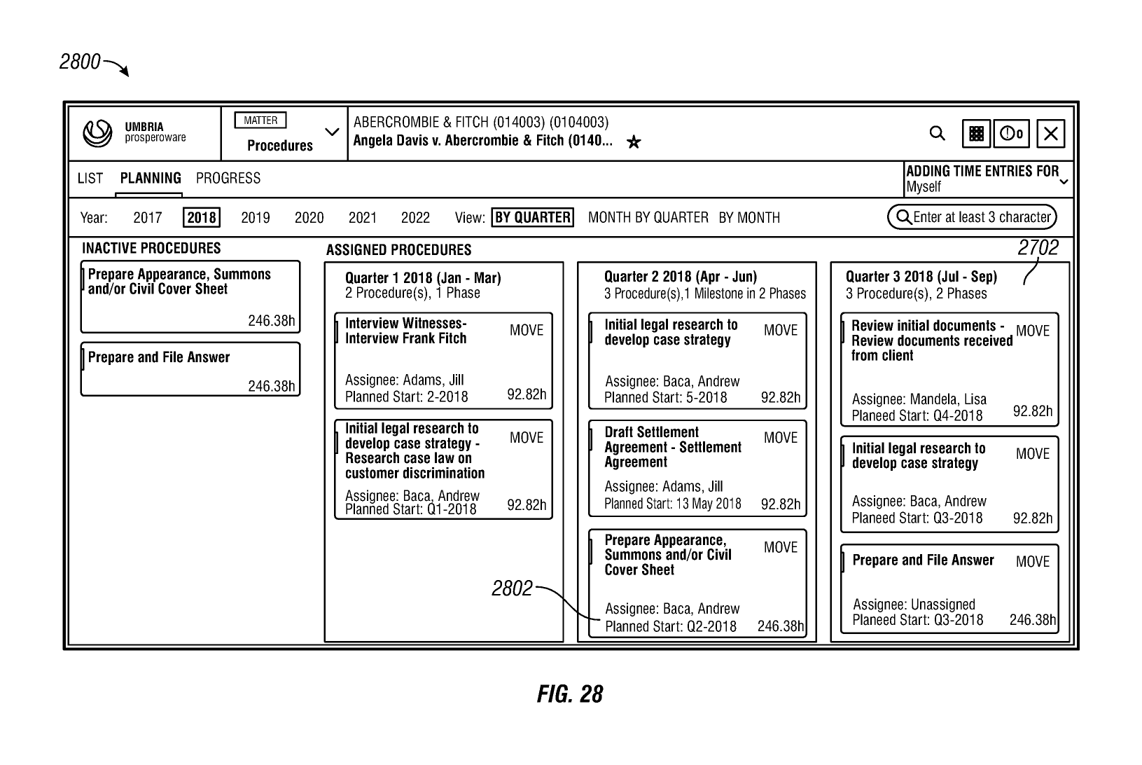

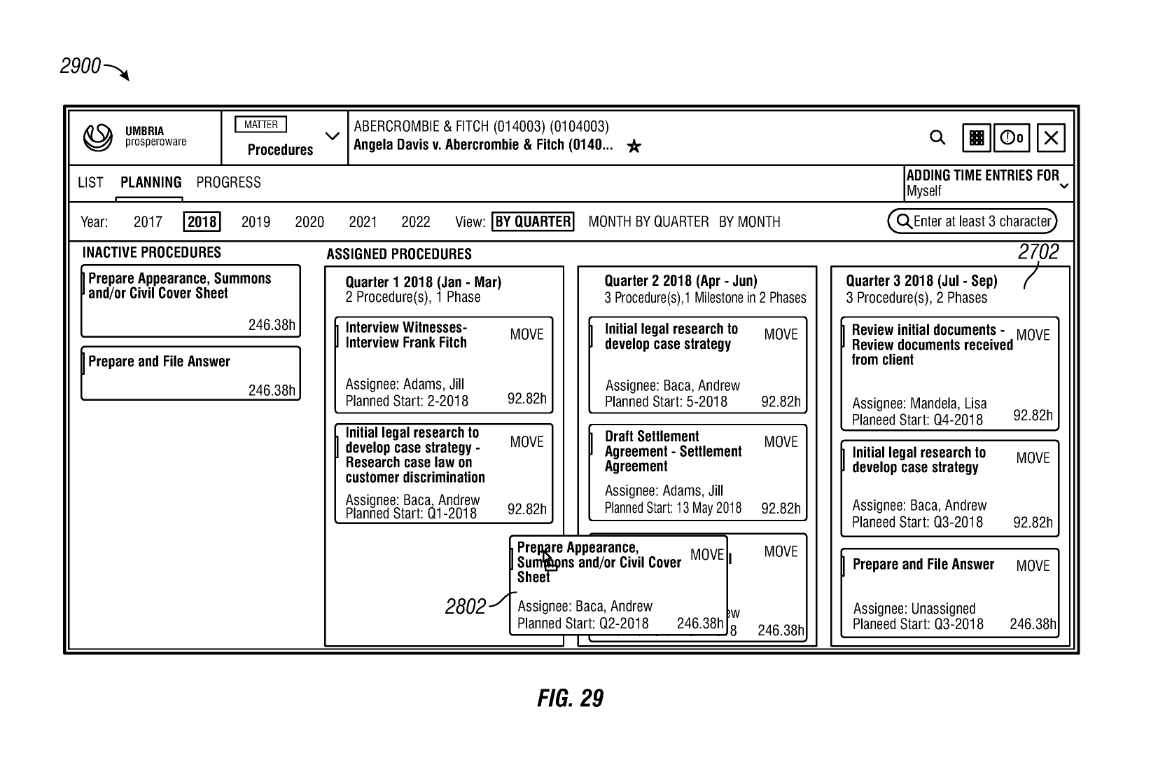

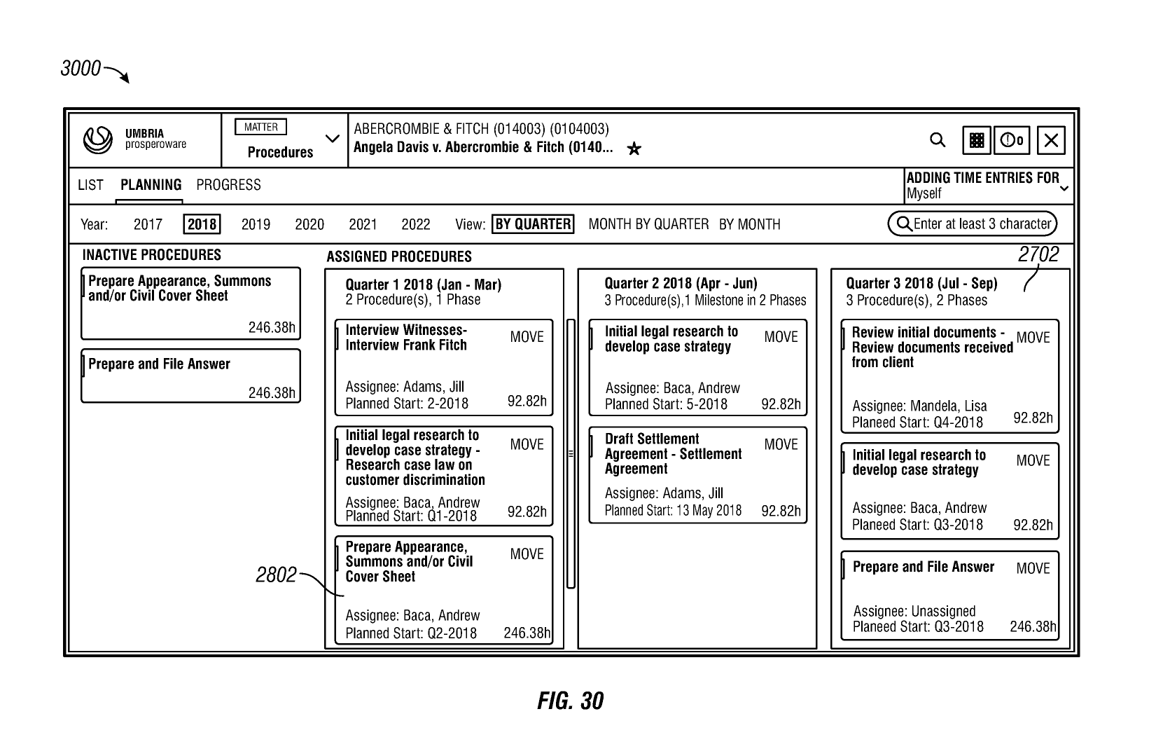

FIGS. 28-30 show the process of moving a procedure object from one phase object to another by means of the device drag-and-drop interface. As shown in FIG. 28, a procedure object 2802 is shown in the Q2 columns: “Prepare Appearance, Summons and or Civil Cover Sheet,” which is to be selected and moved by a user. FIG. 29 shows the procedure object in the process of being dragged from the Q2 column to the Q1 column. FIG. 30 shows the operation having been completed.

Thus, the user may drag-and-drop a procedure object from a list of displayed procedure objects onto a UI representation of the matter object. The user may then define the procedure object by supplying values for the attributes of the procedure object. In embodiments, procedure attributes may include:

a verb-based procedure descriptor;

an estimate of the amount of labor required to complete said procedure; and

an estimate of a cost to complete said procedure.

Thus, the attributes for the matter may constitute a metadata description of the matter. In embodiments, the metadata description may include at least one of:

matter type, sub-type, area of law and country for the matter.

In embodiments, the matter object may be displayed as an ordered list of objects within the UI representation of the matter object.

In embodiments, the procedure object may be pre-populated with default attribute values. The user is free to accept or reject any or all of the default values.

In embodiments, the ordered list of objects may be formatted either as a matter checklist or as a matter budget.

In embodiments, the list of procedure objects may be reordered by the user dragging-and-dropping one or more procedure objects to new positions in the list of procedure objects, as shown above in FIGS. 27-30.

Additionally, addition of a new procedure object to the list may necessitate reordering of the list of procedure objects. Furthermore, subtraction of a procedure object may necessitate reordering of the list of procedure objects.

An additional object used to define the matter is a phase object, representing a phase of a real-world matter. Similar to the procedure object, the user associates a phase object to the matter by dragging-and-dropping and thereafter supplying values for the phase attributes. Phase attributes may include any of:
phase name;
phase code;
start date;
end date; and
phase description.

In embodiments, a list of phase objects represents a selection of phases based on a user-selected filter. In embodiments, certain default procedure objects may be associated to certain phase objects, so that a list of procedure objects from which the user selects is determined by a previous selection of a phase object.

In embodiments, a procedure object may be built from one or more activity objects—an activity object being an object representing an activity needed to complete a procedure. An activity object may be associated to a procedure object using the drag-and-drop operation previously described, following which, values for the activity object attributes are supplied. In embodiments, attributes of an activity object may include:
procedure code;
fee earner class;
person;
base work;
increment; and
expense associated to an increment.

The template objects provide templates for checklist items. Most notably the checklist items constitute procedure objects. But additionally, checklist items may include phase objects, for example and activity objects. A feature of the template objects is that they predefine the time narrative for the type of checklist item. Thus, the time narrative may be considered an attribute of the procedure object.

It will be appreciated that the time narrative for an object is of fundamental importance in legal billing. Clients tend to give the time narrative very close scrutiny when reviewing statements and invoices from law firms. More and more, the time narrative is expected by the client to be completely transparent, providing the client with sufficient information so that it can be understood exactly what the unit of work being billed for is and what it included. It has become common practice for clients to refuse payment for line items in an invoice for which the time narrative does not meet their standards. Additionally, review of law firm invoices with the time narratives is increasingly being automated with the review being performed by software applications.

Although accurate and timely entry of billable time incurred by professionals is essential to the lifeblood of a professional services organization, it is tedious and laborious. Thus, a major technical faced by practitioners involved with providing computing devices for tracking billable time is rendering the devices simple and easy to use, in order to encourage the activity among individual timekeepers in professional services organizations. The present editor and simple-to-use UI provide a technical solution to the technical problem posed by computing devices for timekeeping that make the chore laborious and time-intensive.

Additionally, the editor allows users to view and monitor the financial health of clients and matters they work with. The user interface allows users to look at high-level numbers and KPIs and allows users to drill down into invoices, time narratives and payment information. This also includes viewing receivables at client and matter level. The editor connects to a remote server inside and provides information on a mobile device such as an i-phone, an android phone or a tablet.

As will be understood by those familiar with the art, the methods, systems and devices herein described may be embodied in other specific forms without departing from the spirit or essential characteristics thereof. Likewise, the particular naming and division of the portions, modules, agents, managers, components, functions, procedures, actions, layers, features, attributes, methodologies, data structures and other aspects are not mandatory or significant, and the mechanisms that implement the systems and methods or their features may have different names, divisions and/or formats. The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated. The specification and drawings are, accordingly, to be regarded in an illustrative sense rather than a restrictive sense.

1. An editor for management of matter objects comprising:
at least one non-transitory data store;
a processor; and
a display;
said data store containing computer readable instructions which when executed by a processor implement on said display a drag-and-drop user interface (UI) for managing matter objects;
said computer-readable instructions further comprising instructions for:
defining a matter object responsive to user input;
associating at least one procedure object to said matter object responsive to selection of a procedure object from a displayed list of procedure objects using a pointing device and dragging-and-dropping the selected procedure object onto a UI representation of the matter object;
defining attributes of said at least one procedure object responsive to user input, the attributes comprising at least one of: a verb-based procedure descriptor, an estimate of the amount of labor required to complete said procedure and an estimate of a cost to complete said procedure;
displaying the matter object as an ordered list of procedure objects within the UI representation of the matter object; and
responsive to user input, formatting the display of the ordered list as either a matter checklist or as a matter budget.

2. The editor of claim 1, wherein said matter object comprises any of:
a complex object;
a data structure; and
a class.

3. The editor of claim 1, further comprising computer-readable instructions for:
reordering the list of procedure objects responsive to the user dragging-and-dropping at least one procedure object to a new position in the list of procedure objects from its original position in the list of procedure objects.

4. The editor of claim 1, further comprising computer-readable instructions for:
subtracting a procedure object from the list of procedure objects responsive to a user dragging-and-dropping a procedure object from the UI representation of the matter object.

5. The editor of claim 1, further comprising computer-readable instructions for:
responsive to user input, defining attributes for said matter object, said attributes comprising a metadata description of a real-world matter.

6. The editor of claim 5, wherein said metadata description includes at least one of:
matter type, sub-type, area of law and country for the matter.

7. The editor of claim 1, further comprising computer-readable instructions for:
responsive to the user dragging-and-dropping a phase object from a list of phase objects onto the user interface representation of the matter object, associating the phase object to the matter object, wherein the phase object represents a phase of a real-world matter.

8. The editor of claim 7, further comprising computer-readable instructions for:
responsive to user input, defining attributes of said phase object, the attributes of the phase object including one or more of phase name; phase code; start date; end date; and phase description.

9. The editor of claim 7, wherein said list of phases representing a selection of phases based on a user-selected filter.

10. The editor of claim 9, the list of procedures representing a selection of applicable verb-based templates, based on the selection of phases.

11. The editor of claim 7, further comprising computer-readable instructions for:
responsive to a user dragging-and-dropping an activity object from a list of activity objects to a user interface representation of a procedure object associated to said matter object, associating the activity object to said matter object, said activity object representing an action needed to complete the procedure.

12. The editor of claim 11, further comprising computer-readable instructions for, responsive to user input, defining attributes of said activity object including any of:
procedure code;
fee earner class;
person;
base work;
increment; and
expense associated to an increment.

13. The editor of claim 1, wherein the project budget is formatted as either of:
a top-down budget; and
a bottom-up budget.

14. The editor of claim 1, the computer readable instructions further comprising:
computer-readable instructions for associating document objects generated during a project to the ordered list.
